(19) United States
(12) Patent Application Publication
(10) Pub. No.: US 2025/0119725 A1
(43) Pub. Date: Apr. 10, 2025

(54) METHOD AND SYSTEM FOR MANAGING EMBEDDED SIM (eSIM) PROFILES

(71) Applicant: Samsung Electronics Co., Ltd., Suwon-si (KR)

(72) Inventors: Priyank AGARWAL, Noida (IN); Anuj RAJPUT, Noida (IN); Vikas KUMAR, Noida (IN)

(21) Appl. No.: 18/625,746

(22) Filed: Apr. 3, 2024

Related U.S. Application Data
(63) Continuation of application No. PCT/KR2024/001894, filed on Feb. 8, 2024.

(30) Foreign Application Priority Data
Oct. 6, 2023 (IN) 202311067166

(51) Int. Cl. H04W 8/18

(52) U.S. Cl. CPC H04W 8/18

(57) ABSTRACT

Embodiments of the disclosure describe a method for transferring profile information associated with a physical subscriber identity module (pSIM) of a first electronic device to an embedded SIM (eSIM) of a second electronic device. The method includes creating an enhanced feature short message delivery point (EF-SMDP) file directory in a memory associated with the pSIM. The method includes obtaining eSIM identity (EID) and international mobile equipment identity (IMEI) associated with the eSIM by utilizing a first connection. The method includes sending a first request directly to a subscription manager data preparation (SMDP) server. The method includes obtaining an authorization from the SMDP server for the first request, the first electronic device stores the profile information in a virtual Local Profile Assistant (LPA) module. The method includes transferring the profile information from the virtual LPA module to the eSIM over the first connection.

### CROSS-REFERENCE TO RELATED APPLICATIONS

This application is a continuation of International Application No. PCT/KR2024/001894 designating the United States, filed on Feb. 8, 2024, in the Korean Intellectual Property Receiving Office and claiming priority to Indian Patent Application number 202311067166, filed on Oct. 6, 2023, in the Indian Patent Office, the disclosures of each of which are incorporated by reference herein in their entireties.

### BACKGROUND

### Field

The disclosure relates to the field of embedded Subscriber Identity Module (eSIM), and for example, to a method and a system for transferring profile information associated with a physical SIM (pSIM) of a first electronic device to an eSIM of a second electronic device.

### Description of Related Art

Embedded Subscriber Identity Module (eSIM) is a digital SIM card that is embedded directly into an electronic device (e.g., smartphone, tablet, wearable, etc.). Unlike traditional physical SIM (pSIM) card that need to be inserted or replaced, the eSIM is built into the electronic device during manufacturing. The eSIM is configured to store subscriber information (e.g., network credentials) and enable the electronic device to connect to a mobile network. The eSIM offers various advantages over standard pSIM card. First, manufacturers profit from eSIM technology by cutting production costs and freeing up valuable space on the electronic device's processing board. This enables thinner and more efficient form factors and designs, which is particularly important for waterproof wearables and other small products (e.g., smartwatches). Second, e-SIM provides service providers with new income prospects. It makes it simpler to grow their offers and reach a larger audience by simplifying the process of onboarding new clients and services. This is especially useful in the context of the Internet of Things (IoT), where billions of electronic devices may be efficiently connected. Third, the e-SIM provides case to end users. The users may get the profiles of many mobile network carriers without visiting real retail outlets. This adaptability enables on-demand subscription to data services, encouraging higher data consumption.

The eSIM also includes an Embedded Universal Integrated Circuit Card (eUICC). In other words, the eUICC is a component of the eSIM that facilitates the seamless switching of Mobile Network Operators (MNOs) Over-The-Air (OTA). It also allows for the activation of new MNO profiles through use of remote SIM provisioning (eSIM provisioning), as illustrated in FIG. 1. In the existing eSIM provisioning system, the user utilizes one or more modules when the user of the electronic device wants to transfer profile information associated with the pSIM card of a first electronic device (old UE) to an eSIM of a second electronic device (new UE), as illustrated in FIG. 1, FIG. 2, and FIG. 3. The one or more modules includes a Subscription Manager Data Preparation (SM-DP), a Discovery Server (SM-DS), a Credential Issuer (CI), an EUICC Update Manager (EUM), the eUICC, an end user, and an operator. The one or more modules and interfaces work together to enable the safe and fast provisioning of eSIM, providing end users with freedom and convenience while letting operators successfully manage their subscriber base. The functionality/definition of the one or more modules and interfaces, for example, are described in Table-1 and Table-2 below.

TABLE-1

| One or more | |
|---|---|
| modules | Functionality/definition |
| SM-DP | The SM-DP is configured to prepare and personalize subscription data |
| | for the eSIM, which includes generating and encrypting the necessary |
| | profiles for the MNOs. |
| SM-DS | The SM-DS is configured to serve as a central registry that helps |
| | eUICCs discover and connect to appropriate SM-DP. It assists in |
| | routing eUICC requests to the appropriate SM-DP. |
| CI | The CI is configured to generate and manage one or more |
| | cryptographic keys and certificates required for secure communication |
| | between the eUICC and the SM-DP. |
| EUM | The EUM is configured to manage updates to eUICC software and |
| | profiles. It ensures that the eUICC remains up to date with the latest |
| | profiles and security patches. |
| eUICC | The eUICC is configured to store multiple carrier profiles and |
| | facilitates secure provisioning, switching between carriers, and remote |
| | management. |
| end user | The end user is the electronic device owner or consumer, who gains |
| | from eSIM provisioning by being able to transfer carriers or activate |
| | new mobile plans remotely. |
| operator | Operator (MNO) is a company that provides mobile services and |
| | network access. To onboard new users and manage current ones, they |
| | employ eSIM provisioning. |

TABLE-2

| Interface | Between | | Description |
|---|---|---|---|
| ES2+ | Operator | SM-DP+ | Used by the Operator to order Profiles for specific eUICCs as well |
| | | | as other administrative functions. |
| ES6 | Operator | eUICC | Used by the Operator for the management of |
| | | | operator services via OTA services. |
| ES8+ | SM-DP+ | eUICC | Provides a secure end-to-end channel between the |
| | | | SMDP+ and the eUICC for the administration of |
| | | | the ISD-P and the associated Profile during |
| | | | download and installation. it provides perfect |
| | | | forward secrecy. |
| ES9+ | SM-DP+ | LPD | Used to provide a secure transport between the |
| | | | SM-DP+ and the LPA (LPD) for the delivery of |
| | | | the bound profile package. |
| ES10a | LDSd | eUICC | Used between the LDSd and the LPA Services to |
| | | | handle a profile discovery. |
| ES10b | LPDd | eUICC | Used between the LPDd and the LPA services to |
| | | | transfer a Bound Profile Package to the eUICC. |
| | | | This interface plays no role in the decryption of |
| | | | profile packages. |
| ES10c | LUId | eUICC | Used between the LUId and the LPA services for |
| | | | Local Profile Management by the End User. |
| ES11 | LDS | SM-DS | Used by the LDS to retrieve event records for the |
| | | | respective eUICC. |
| ES12 | SM-DP+ | SM-DS | Used by the SM-DP+ to issue or remove event |
| | | | registrations on the SM-DS. |
| ES15 | SM-DS | SM-DS | Used in the case of deployments of cascaded SM- |
| | | | DSs to connect those SM-DSs |
| ESop | Operator | End User | The business interface between Operator and End- |
| | | | user. |
| ESeu | End User | LUI | Interface to initiate local profile management |
| | | | functions. |
| ESeum | eUICC | EUM | The administrative interface between the eUICC |
| | | | vendor (EUM) and the eUICC. |
| ESci | CI | SM-DP+ | This interface is used by the SM-DP+, SM-DS, |
| | | SM-DS | and EUM to request a Certificate and retrieve |
| | | EUM | Certificate revocation status. Any other relying |
| | | | party may retrieve the certificate revocation |
| | | | status. The interface for Certificate Signing |
| | | | request is defined in SGP.14 [45] section 5.1. The |
| | | | interface for CRL retrieval is defined in the |
| | | | present document, section 4.5.2.1.3 |
| | | | “extension CRL distribution points” |
| ESdloa | DLOA | Manage- | This interface is defined in GlobalPlatform DLOA |
| system | registrar | ment | [57] section 5. |
| | | system | |

The existing eSIM provisioning mechanism offers several benefits. However, when the user of the electronic device wishes to transfer profile information connected with the pSIM of the first electronic device (old UE) to the eSIM of the second electronic device (new UE) as illustrated in FIG. 2 and FIG. 3, it has encountered a few problems, which are mentioned below.

One notable problem is a complexity of pSIM authentication. This pSIM authentication process involves multiple steps, and even a minor mistake during any of these steps can trigger retries, as illustrated in FIG. 3, as discussed later in the description. Excessive retry attempts can result in temporary blocking. Furthermore, the cost associated with the pSIM authentication process, associated with entitlement/SMDS, is relatively high. The sophisticated structure of the pSIM authentication process, with its various phases, creates security concerns and presents overhead difficulties. Another significant problem is a configuration of eSIM for Machine-to-Machine (M2M) or Internet of Things (IoT) device. These devices frequently lack user interfaces, making eSIM configuration difficult. Interacting with and setting eSIM for the M2M/IoT device becomes difficult without a user-friendly interface.

Examples of the existing eSIM provisioning mechanisms may include a Quick Response (QR) code-based eSIM activation, a by-default SM-DP+ address-based eSIM activation, a Global System for Mobile Communication Association (GSMA) root discovery service-based eSIM activation, and initial connectivity-based eSIM activation. Each mechanism has various issues, which are listed below.

In the QR code-based eSIM activation, to activate the eSIM with the QR code, the user must first acquire an eSIM voucher with the QR code, check electronic device compatibility, and have a valid eSIM-supporting plan. The user then scans the QR code with a camera of the electronic device and follows specified instructions to activate the eSIM. It may take a few minutes for the eSIM to activate and enable cellular access. The user may find this mechanism quite complicated since it requires checking compatibility, purchasing vouchers, and completing the specified instructions. Furthermore, the mechanism may take some time, causing delays in connecting.

In by-default SM-DP+ address-based eSIM activation, the eUICC is pre-provisioned with the operator's remote SIM provisioning platform (SM-DP+) address during manufacturing. It makes eSIM usage and activation easier, especially for operator-subsidized eSIM-enabled electronic device. In most cases, the user must acquire both an operator-subsidized electronic device and an operator's subscription. This mechanism is confined to operator-subsidized electronic device and requires user to purchase specific electronic device and subscriptions. It may not be suited for all users.

In GSMA's root discovery service-based eSIM activation, the mechanism is designed for an operator-subsidized eSIM-enabled electronic device. When the electronic device is switched on for a first time, it automatically retrieves an eSIM profile (profile information) corresponding to the user's mobile subscription OTA. Like the previous mechanism, it's primarily for the operator-subsidized electronic device, and the user must purchase both the subsidized electronic device and the mobile operator's subscription. This mechanism is convenient, but it has restrictions.

In initial connectivity-based eSIM activation, to download the eSIM profile, the eSIM-ready device must initially connect to a mobile network via Wi-Fi, smartphone tethering, or bootstrap connectivity. A primary connection with SM-DS is still required the first time the electronic device connects to the network's SM-DP+ server. This mechanism demands the electronic device to have some form of internet connectivity before the eSIM profile can be downloaded. It includes an initial setup process that necessitates connectivity.

Thus, it is desired to address the above-mentioned disadvantages or other shortcomings or at least provide a useful alternative for transferring the profile information associated with the pSIM of the first electronic device to the eSIM of the second electronic device.

### SUMMARY

According to an example embodiment of the present disclosure, a method for transferring profile information associated with a physical subscriber identity module (pSIM) of a first electronic device to an embedded SIM (eSIM) of a second electronic device is disclosed herein. The method includes creating, by the first electronic device, an enhanced feature short message delivery point (EF-SMDP) file directory in a memory associated with the pSIM. The method includes obtaining, by the first electronic device, eSIM identity (EID) and international mobile equipment identity (IMEI) associated with the eSIM of the second electronic device utilizing a first connection associated with the first electronic device and the second electronic device. The method includes sending, using the created EF-SMDP file directory, the obtained EID, and the obtained IMEI, by the first electronic device, a first request to a subscription manager data preparation (SMDP) server. The method includes obtaining, by the first electronic device, an authorization from the SMDP server for the first request, wherein the first electronic device stores, based upon authorization, the profile information in a virtual Local Profile Assistant (LPA) module associated with the pSIM of the first electronic device. The method includes transferring, by the first electronic device, the profile information from the virtual LPA module to the eSIM of the second electronic device over the first connection.

According to an example embodiment of the present disclosure, a method for handling profile information is associated with the pSIM of the first electronic device at the eSIM of the second electronic device. The method includes receiving, by the second electronic device, the first connection from the first electronic device to obtain the EID and the IMEI associated with the eSIM of the second electronic device. The method includes sending, by the second electronic device, the EID and the IMEI associated with the eSIM of the second electronic device to the first electronic device to obtain the profile information. The method includes receiving, by the second electronic device, the profile information from the virtual LPA module of the first electronic device over the established first connection. The method includes installing, by the second electronic device, the received profile information in embedded universal integrated circuit card (e-UICC) module associated with the eSIM. The method includes initializing, upon installing the received profile information, by the second electronic device, a connection with the network entity, wherein the second electronic device receives network information from the network entity and the network information comprises at least one of a mobile country code (MCC), a mobile network code (MNC), a last registered public land mobile network (PLMN), and other data, wherein the other data comprises at least one of radio access technology (RAT) information, contact information, and user preference information.

According to an example embodiment of the present disclosure, a system for transferring profile information associated with the pSIM of the first electronic device to the eSIM of the second electronic device is disclosed. The system includes a memory, communication circuitry and at least one processor, comprising processing circuitry, coupled with one or more modules comprising executable instructions associated with the first electronic device and the second electronic device. At least one processor, individually and/or collectively, configured to create the EF-SMDP file directory in the memory associated with the pSIM. At least one processor, individually and/or collectively, is configured to obtain the EID and the IMEI associated with the eSIM of the second electronic device utilizing the first connection associated with the first electronic device and the second electronic device. At least one processor, individually and/or collectively, is configured to send, using the created EF-SMDP file directory, the obtained EID, and the obtained IMEI, by the first electronic device, the first request directly to the SMDP server. At least one processor, individually and/or collectively is configured to obtain the authorization from the SMDP server for the first request, wherein the first electronic device is configured to store, based upon authorization, the profile information in the virtual LPA module associated with the pSIM of the first electronic device. At least one processor, individually and/or collectively, is configured to transfer the profile information from the virtual LPA module to the eSIM of the second electronic device over the first connection.

According to an example embodiment of the present disclosure, a system for handling profile information is associated with the pSIM of the first electronic device at the eSIM of the second electronic device. The system includes: memory, communication circuitry and at least one processor, comprising processing circuitry, coupled with one or more modules comprising executable instructions associated with the first electronic device and the second electronic device. At least one processor, individually and/or collectively, is configured to receive the first connection from the first electronic device to obtain the EID and the IMEI associated with the eSIM of the second electronic device. At least one processor, individually and/or collectively, is configured to send the EID and the IMEI associated with the eSIM of the second electronic device to the first electronic device to obtain the profile information. At least one processor, individually and/or collectively, is configured to receive the profile information from the virtual LPA module of the first electronic device over the established first connection. At least one processor, individually and/or collectively, is configured to install the received profile information in the e-UICC module associated with the eSIM. At least one processor, individually and/or collectively, is configured to initialize, upon installing the received profile information, the connection with the network entity, wherein the second electronic device is configured to receive network information from the network entity and the network information comprises at least one of the MCC, the MNC, the last registered PLMN, and other data, wherein the other data comprises at least one of the RAT information, the contact information, and the user preference information.

To further clarify the advantages and features of the disclosure, a more detailed description of the various example embodiments will be provided with reference to the drawings. It will be appreciated that these drawings depict example embodiments and are therefore not to be considered limiting of its scope.

### BRIEF DESCRIPTION OF THE DRAWINGS

These and other features, aspects, and advantages of certain embodiments of the present disclosure will be more apparent from the following detailed description, taken in conjunction with the accompanying drawings in which like characters represent like parts throughout the drawings, an in which:

FIG. 1 is a system block diagram illustrating a configuration of an existing eSIM provisioning mechanism, according to the prior art;

FIG. 2 is a diagram illustrating an existing hardware architecture associated with a pSIM-based old User Electronic (UE) and an eSIM-based new UE that are used for transferring profile information from the old UE to the new UE by utilizing the existing eSIM provisioning mechanism, according to the prior art;

FIG. 3 is a signal flow diagram illustrating a method for the existing eSIM provisioning mechanism, according to the prior art;

FIGS. 4A and 4B are signal flow diagrams illustrating an example method for transferring profile information associated with a pSIM of a first electronic device (old UE) to an eSIM of a second electronic device (new UE), according to various embodiments;

FIG. 5 is a block diagram illustrating an example configuration of a system for transferring the profile information from the first electronic device to the second electronic, according to various embodiments;

FIG. 6 is a signal flow diagram illustrating an example method for generating an envelope command, according to various embodiments;

FIGS. 7A and 7B are diagrams illustrating example architectures associated with a SIM toolkit (STK) module, according to various embodiments;

FIG. 8 is a diagram illustrating one or more layers associated with a user identity module (UIM) module, according to various embodiments;

FIG. 9 is a signal flow diagram illustrating an example method for storing one or more values associated with an EF-SMDP file directory in a virtual LPA module of the first electronic device, according to various embodiments;

FIG. 10 is a flowchart illustrating an example method for storing the one or more values associated with the EF-SMDP file directory in the virtual LPA module of the first electronic device, according to various embodiments;

FIG. 11 is a signal flow diagram illustrating an example method for storing the one or more received profile parameters associated with the profile information in the virtual LPA module of the first electronic device, according to various embodiments;

FIG. 12A is a signal flow diagram illustrating an example method for transferring the profile information, according to various embodiments;

FIG. 12B is a diagram illustrating one or more modules associated with the second electronic device for transferring the profile information, according to various embodiments;

FIG. 13 is a flowchart illustrating an example method for transferring profile information associated with the pSIM of the first electronic device to the eSIM of the second electronic device, according to various embodiments;

FIG. 14 is a flowchart illustrating an example method for handling the profile information associated with the pSIM of the first electronic device at the eSIM of the second electronic device, according to various embodiments; and

FIGS. 15A and 15B are diagrams illustrating example scenarios where a user transfers the profile information associated with the pSIM of the first electronic device to the eSIM of the second electronic device, according to various embodiments.

FIG. 16 is a block diagram illustrating a structure of a device.

FIG. 17 is a block diagram illustrating a structure of an entity.

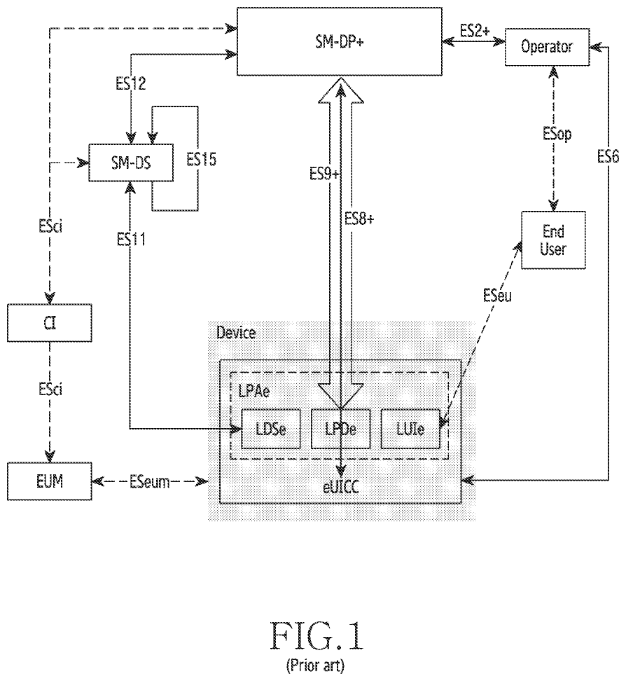

Further, skilled artisans will appreciate that elements in the drawings are illustrated for simplicity and may not have necessarily been drawn to scale. For example, the flowcharts illustrate the method involved to help to improve understanding of aspects of the disclosure. Furthermore, in terms of the construction of the device, one or more components of the device may have been represented in the drawings by conventional symbols, and the drawings may show specific details that are pertinent to understanding the embodiments of the disclosure so as not to obscure the drawings with details that will be readily apparent to those of ordinary skill in the art having the benefit of the description herein.

### DETAILED DESCRIPTION

For the purpose of promoting an understanding of the principles of the disclosure, reference will now be made to various example embodiments illustrated in the drawings and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory and are not intended to be restrictive thereof.

Reference throughout this disclosure to “an aspect”, “another aspect” or similar language may refer, for example, to a particular feature, structure, or characteristic described in connection with the embodiment being included in at least one embodiment of the disclosure. Thus, appearances of the phrase “in an embodiment”, “in one embodiment”, “in another embodiment”, and similar language throughout this disclosure may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The embodiments herein and the various features and advantageous details thereof are explained more fully with reference to the various example non-limiting embodiments that are illustrated in the accompanying drawings and detailed in the following description. Descriptions of well-known components and processing techniques may be omitted so as to not unnecessarily obscure the embodiments herein. The various embodiments described herein are not necessarily mutually exclusive, as various embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

Various example embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits of a block may be implemented by dedicated hardware, or by a processor (e.g., one or more programmed microprocessors, processing circuitry and/or associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

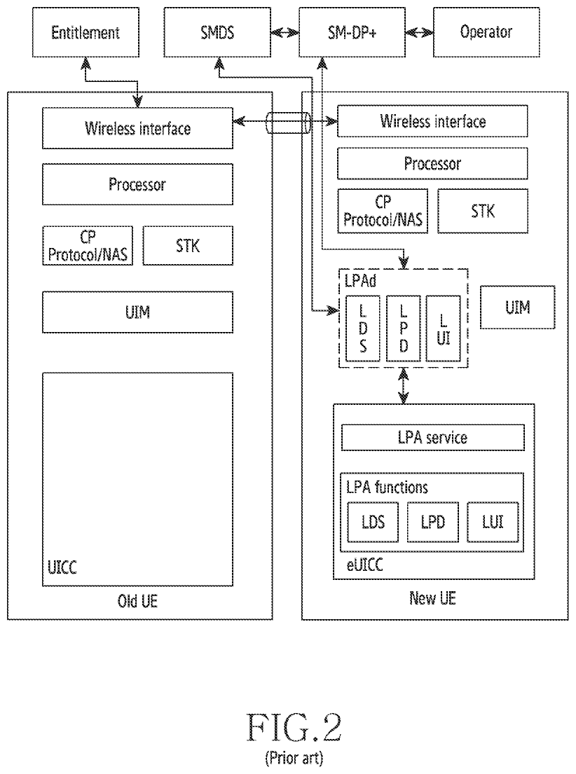

FIG. 2 is a diagram illustrating an existing hardware architecture associated with a pSIM-based old User Electronic (UE) and an eSIM-based new UE that are used for transferring profile information from the old UE to the new UE by utilizing the existing eSIM provisioning mechanism, according to the prior art. The existing eSIM provisioning mechanism may utilize one or more modules to transfer the profile information from the old UE to the new UE. The one or more modules comprise an entitlement server, an SMDS server, an SM-DP+ server, and an operator, as described in Table-1. The old UE comprises a wireless interface, a processor, a CP protocol/NAS module, a SIM toolkit (STK), a user identity module (UIM), and a universal integrated circuit card (UICC). The new UE comprises a wireless interface, a processor, a CP protocol/NAS module, an STK, a UIM, an embedded Universal Integrated Circuit Card (eUICC), and an LPA module.

The LPA module is a functional element in the new UE or in the eUICC that provides a Local Profile Download (LPD), a Local Discovery Services (LDS), and a Local User Interface (LUI). The LUI is a part of the LPA module, and it takes care of a UI part of the LPA module, which is used by an end-user for local profile management. The LPD is also a part of the LPA module and is used to provide a secure transport between the SM-DP+ server and the LPA (LPD) for the delivery of a bound profile package.

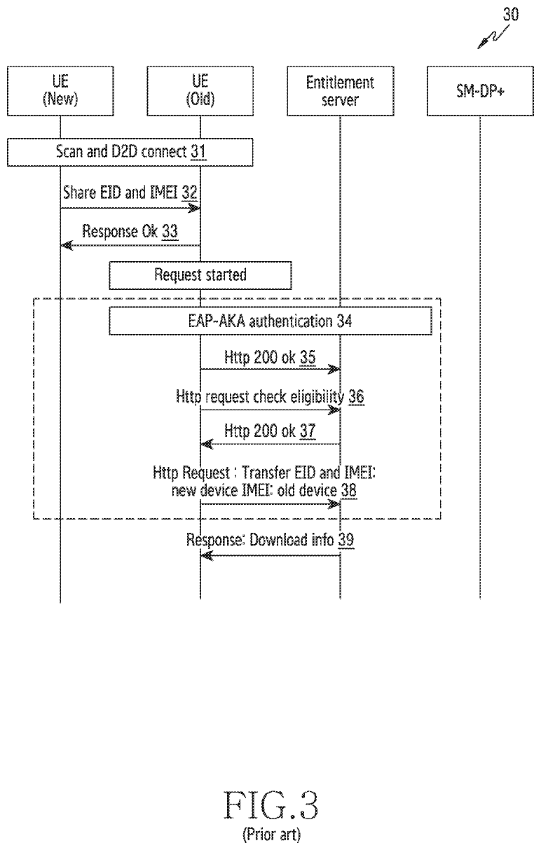

FIG. 3 is a signal flow diagram illustrating a method 30 for the existing eSIM provisioning mechanism, according to the prior art.

At step 31, the old UE scans for the new UE and connects with the new UE by utilizing a Device to Device (D2D) connection, when the old UE detects that the user of the old UE wants to transfer the profile information associated with the pSIM-based old UE to the eSIM based new UE. At step 32, the old UE obtains the eSIM identity (EID) and international mobile equipment identity (IMEI) associated with the eSIM. At step 33, the old UE sends an acknowledgement message to the new UE upon obtaining the EID and the IMEI associated with the eSIM.

At steps 34, 35, 36, 37, and 38, the old UE utilizes an Extensible Authentication Protocol-Authentication and Key Agreement (EAP-AKA) authentication of SIM and initiates a SIM transfer (e.g., pSIM/eSIM) call flow (transferring profile information) by utilizing the entitlement server. At step 39, the entitlement server completes the SIM transfer by delivering a necessary information (download information) of the SM-DP+ server. This includes processing a profile download request from the new UE and ensuring that it is successfully downloaded onto the new UE.

One notable problem with the existing eSIM provisioning mechanism is a complexity of pSIM authentication. This SIM (pSIM/eSIM) authentication process involves multiple steps, and even a minor mistake during any of these steps can trigger retries (e.g., step 34 to step 38). Excessive retry attempts can result in temporary blocking. Further, the cost associated with the SIM authentication process, associated with entitlement server/SMDS, is relatively high. In other words, the SIM authentication process requires an extra authentication server (e.g., entitlement server). The sophisticated structure of the SIM authentication process, with its various phases, creates security concerns and presents overhead difficulties. Furthermore, one of the limitations/problems of the existing eSIM provisioning mechanism is that it can only be applied to UEs that are pSIM+eSIM compatible. This restriction may pose a challenge for those who do not have access to such UEs. Therefore, it is advisable to explore alternative options that are more inclusive and accessible to a wider range of users.

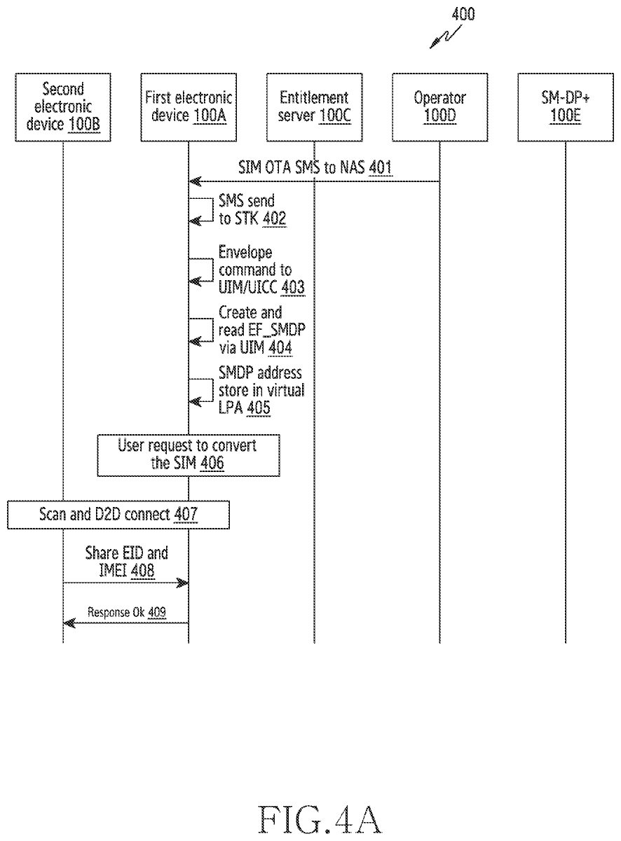

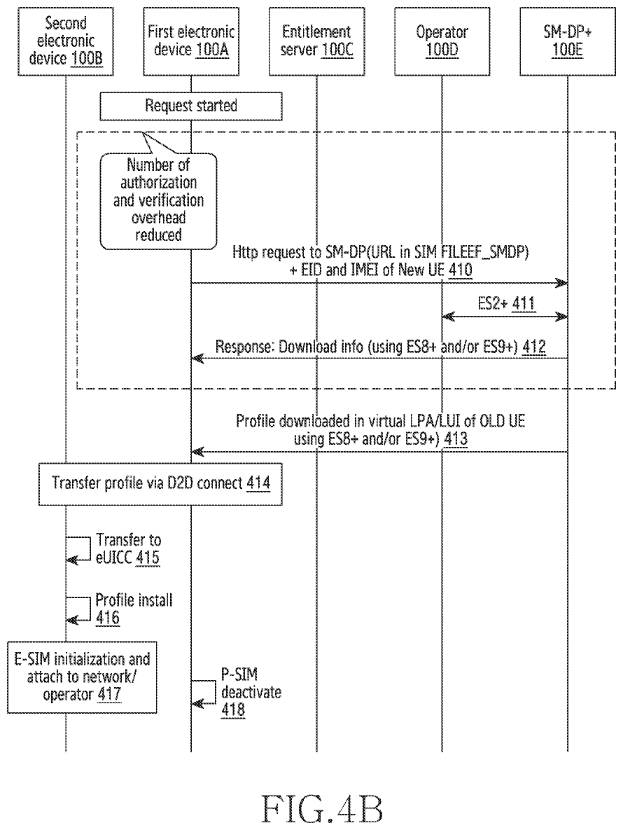

To address these problems, a disclosed method provides a unique strategy for transferring the profile information associated with the pSIM of the first electronic device (old UE) to the eSIM of the second electronic device (new UE), as described in conjunction with FIG. 4A to FIG. 15B.

Referring now to the drawings, and more particularly to FIGS. 4A to 15B, where similar reference characters denote corresponding features consistently throughout the figures, there are shown various example embodiments.

FIGS. 4A and 4B are signal flow diagrams illustrating an example method 400 for transferring profile information associated with a pSIM of a first electronic device (e.g., old UE) 100A to an eSIM of a second electronic device (e.g., new UE) 100B, according to various embodiments.

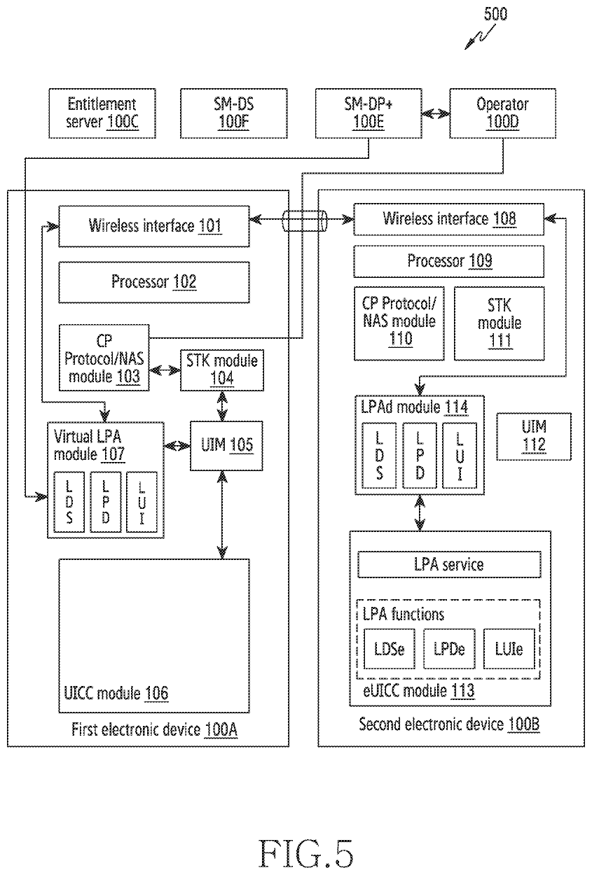

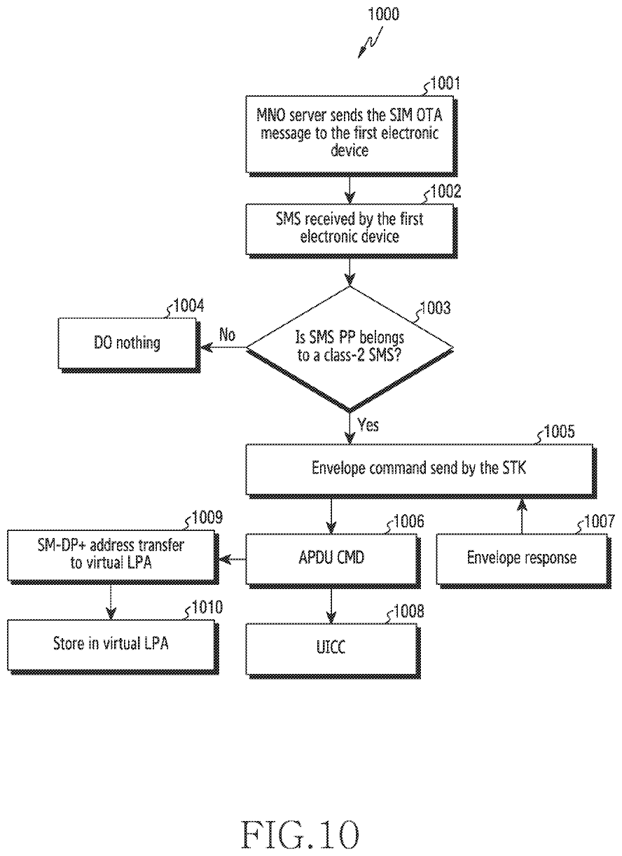

Referring to FIG. 4A: At step 401, the method 400 includes receiving, by the first electronic device 100A, a SIM over-the-air (OTA) message a the network entity (e.g., operator 100D) to create the EF-SMDP file directory. The method 400 further includes determining, by the first electronic device 100A, whether a Short Message Service Point to Point (SMS-PP) message for the received SIM OTA message belongs to a class-2 SMS, as described in greater detail below with reference to FIG. 5 and FIG. 10.

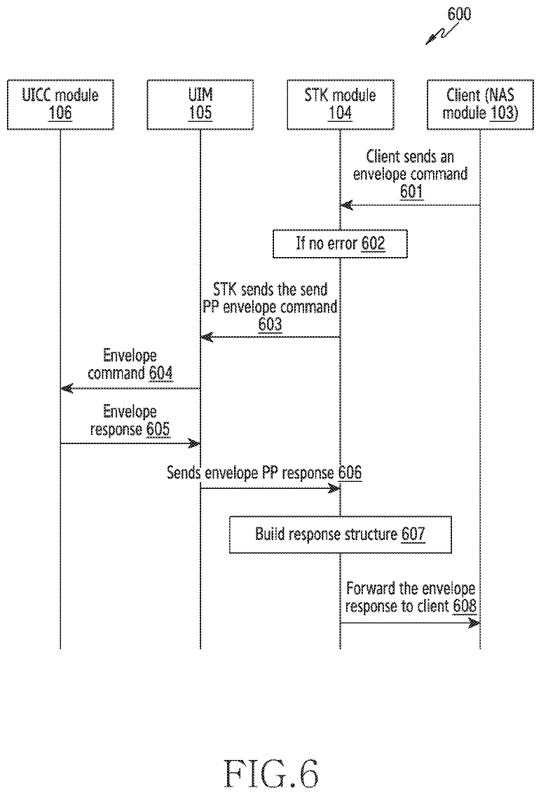

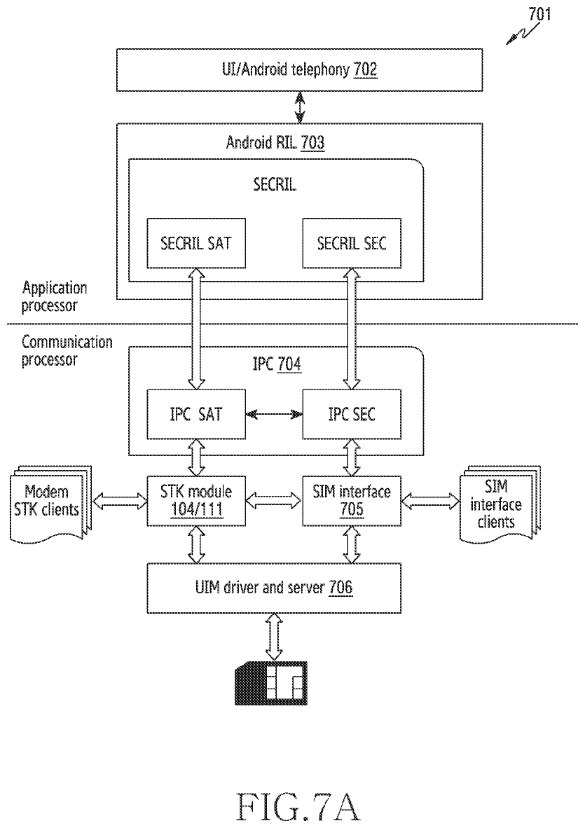

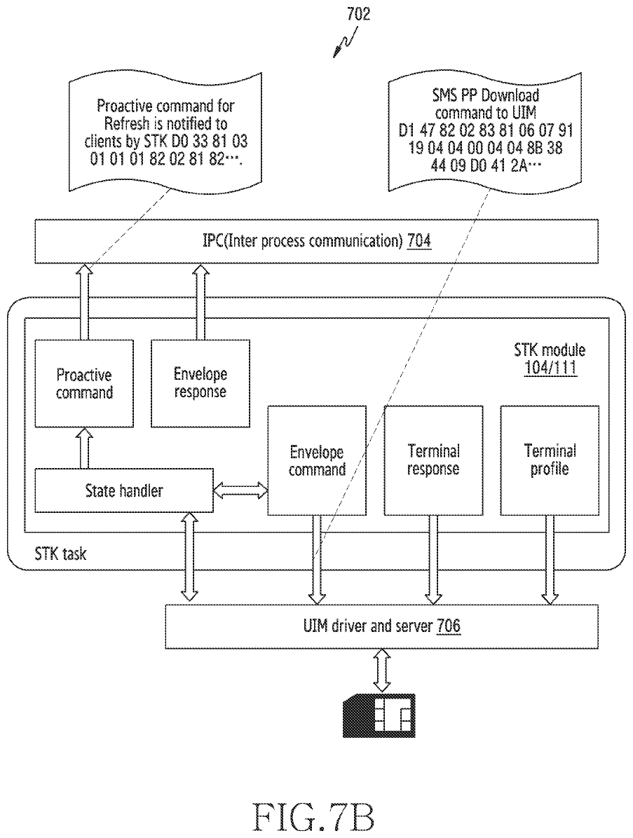

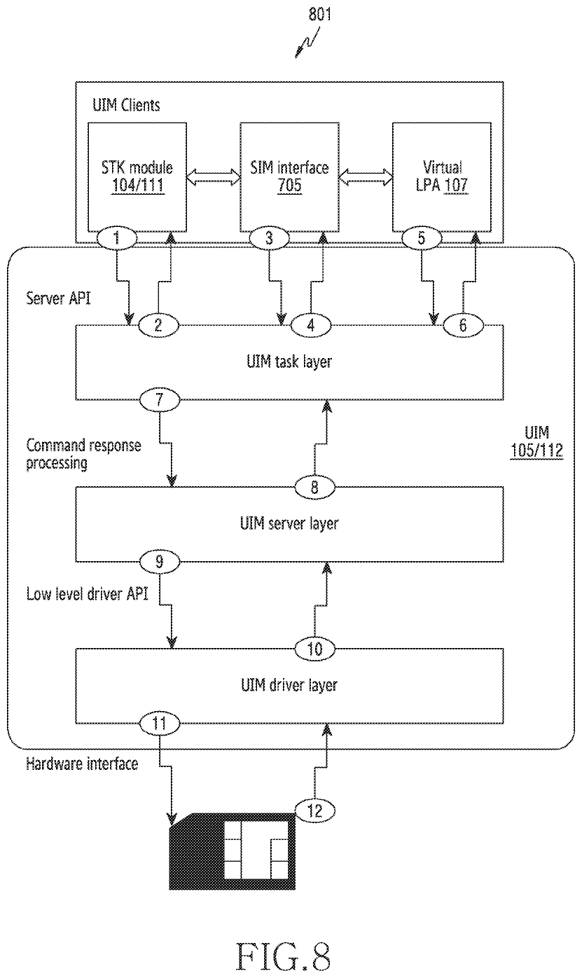

At step 402, the method 400 includes sending, by a SIM toolkit (STK) module of the first electronic device 100A, an envelope command to a user identity module (UIM) of the first electronic device 100A in response to determining that the SMS-PP message belongs to the class-2 SMS, as described in greater detail below with reference to FIG. 5, FIG. 6, FIG. 7A, FIG. 7B, and FIG. 8.

At step 403, the method 400 includes generating, upon receiving the envelop command, by the UIM, an application protocol data unit (APDU) command to pass information associated with the received SIM OTA message to a universal integrated circuit card (UICC) module of the first electronic device 100A, as described in greater detail below with reference to FIG. 5, FIG. 8, and FIG. 10.

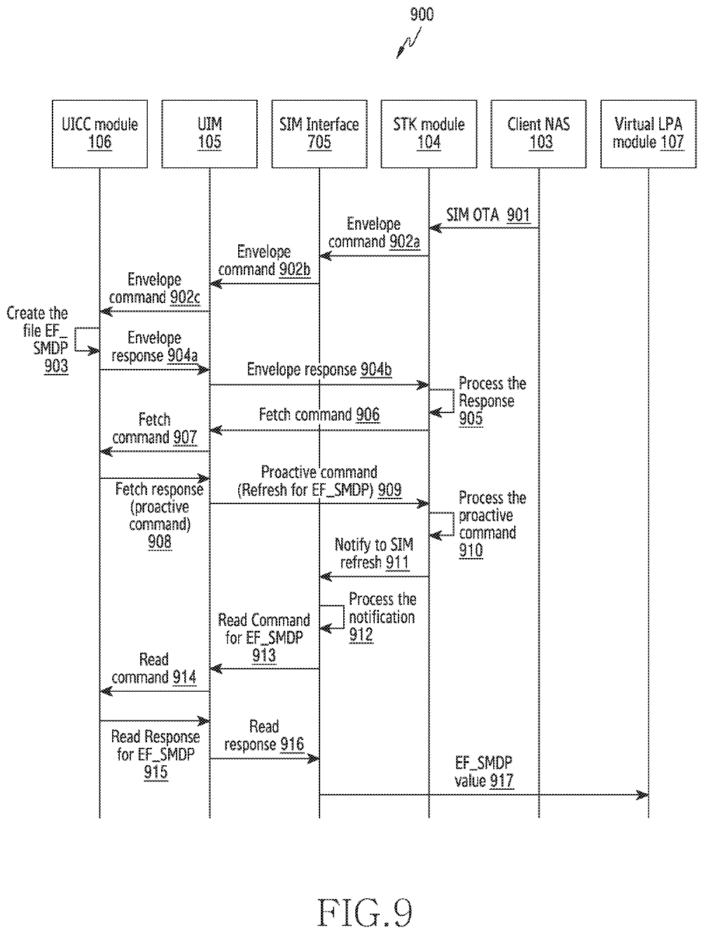

At step 404, the method 400 includes performing, by the UICC module of the first electronic device 100A, one or more operations to create the EF-SMDP file directory. The one or more operations comprise receiving the information associated with the received SIM OTA message and decoding the information associated with the received SIM OTA message based on one or more pre-defined rules. The method 400 includes creating, based upon the one or more operations, by the UICC module of the first electronic device 100A, the EF-SMDP file directory, as described in greater detail below with reference to FIG. 5, FIG. 9, and FIG. 10.

At step 405, the method 400 includes generating, by the UICC module of the first electronic device 100A, a refresh proactive command, based on one or more pre-defined rules (according TO 3GPP TS 11.14), to be read by the UIM. The method 400 further includes determining, by the UIM of the first electronic device 100A, one or more values associated with the created EF-SMDP file directory. The method 400 further includes storing, by the first electronic device 100A, the one or more values associated with the created EF-SMDP file directory in the virtual LPA module of the first electronic device 100A, as described in greater detail below with reference to FIG. 5, FIG. 9, and FIG. 10. The method 400 includes storing, by the first electronic device 100A, the created EF-SMDP file directory in the virtual LPA module of the first electronic device 100A. The virtual LPA module comprises a local profile download (LPD) module, a local discovery services (LDS) module, and a local user interface (LUI) module. The created EF-SMDP file directory comprises SMDP server information along with a uniform resource locator (URL).

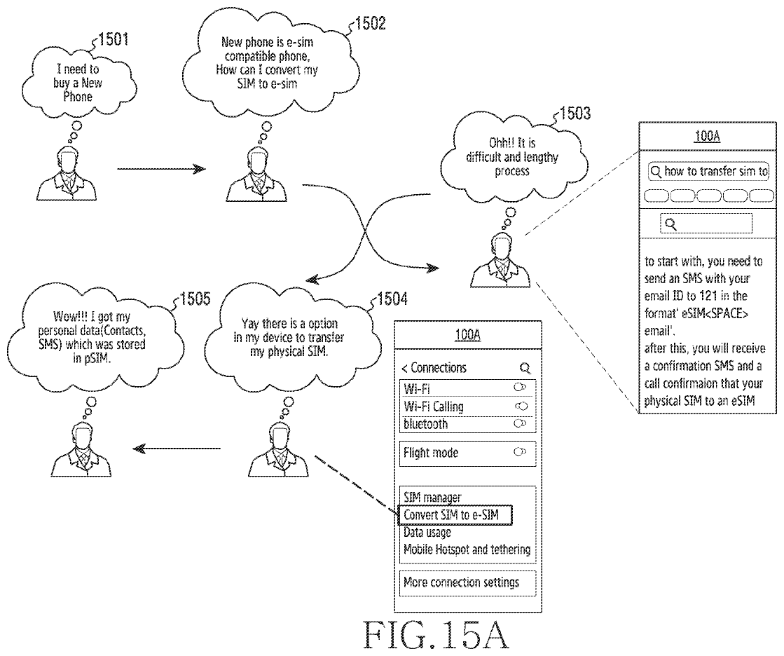

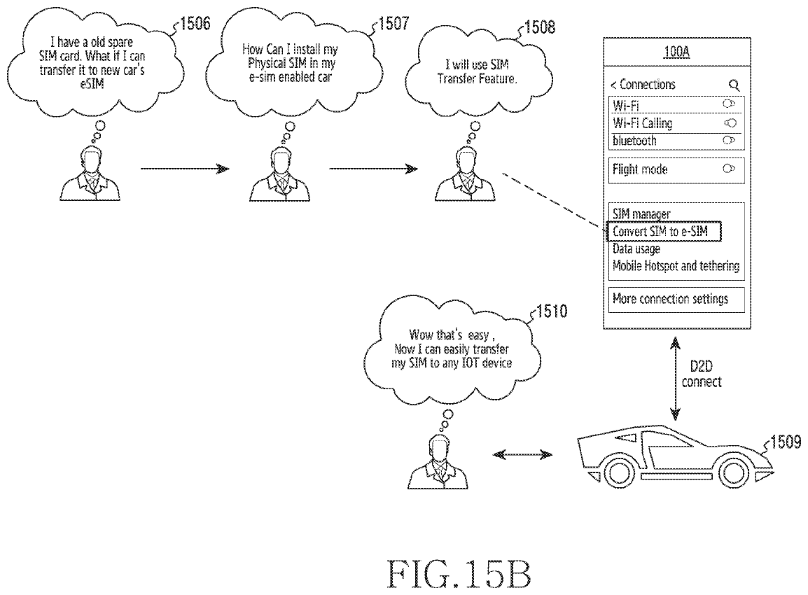

At step 406, the method 400 includes receiving, by the first electronic device 100A, a SIM conversion request from the user over a first connection, as described in greater detail below with reference to FIG. 15A and FIG. 15B. At step 407, the method 400 includes determining, upon receiving the SIM conversion request, by the first electronic device 100A, whether the second electronic device 100B is eSIM compatible, based on the obtained EID associated with the second electronic device 100B. The method 400 further includes establishing, by the first electronic device 100A, the first connection (e.g., D2D connection) with the second electronic device 100B in response to determining that the second electronic device 100B is eSIM compatible, as described in greater detail below with reference to FIG. 15A and FIG. 15B.

At step 408, the method 400 includes obtaining, by the first electronic device 100A, eSIM identity (EID) and international mobile equipment identity (IMEI) associated with the eSIM of the second electronic device 100B by utilizing the first connection associated with the first electronic device 100A and the second electronic device 100B. At step 409, the method 400 includes sending a response message to the second electronic device 100B upon receiving the EID and the IMEI.

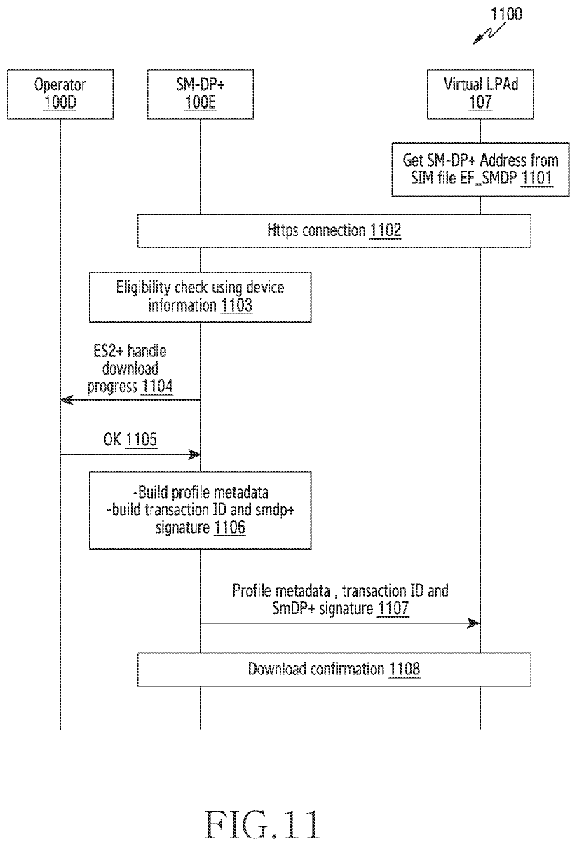

Referring to FIG. 4B: At step 410, the method 400 includes sending, using the created EF-SMDP file directory, the obtained EID, and the obtained IMEI, by the first electronic device 100A, a first request directly to a subscription manager data preparation (SMDP) server 100E (e.g., SM-DP+). At step 411, the method 400 includes utilizing an ES2+ connection between the operator 100D and the SMDP server 100E to order profiles for specific UICCs. At steps 412-413, the method 400 includes utilizing an ES8+ connection between a virtual LPA of the first electronic device 100A and the SMDP server 100E to provide a secure end-to-end channel for an administration of ISD-P and associated profile during download and utilizing an ES9+ connection between the virtual LPA of the first electronic device 100A and the SMDP server 100E to provide secure transport for a delivery of bound profile package (profile information). In other words, the method 400 includes obtaining, by the first electronic device 100A, an authorization from the SMDP server 100E for the first request, wherein the first electronic device 100A stores, based upon authorization, the profile information in the virtual LPA module associated with the pSIM of the first electronic device 100A, as described in greater detail below with reference to FIG. 11, FIG. 15A and FIG. 15B.

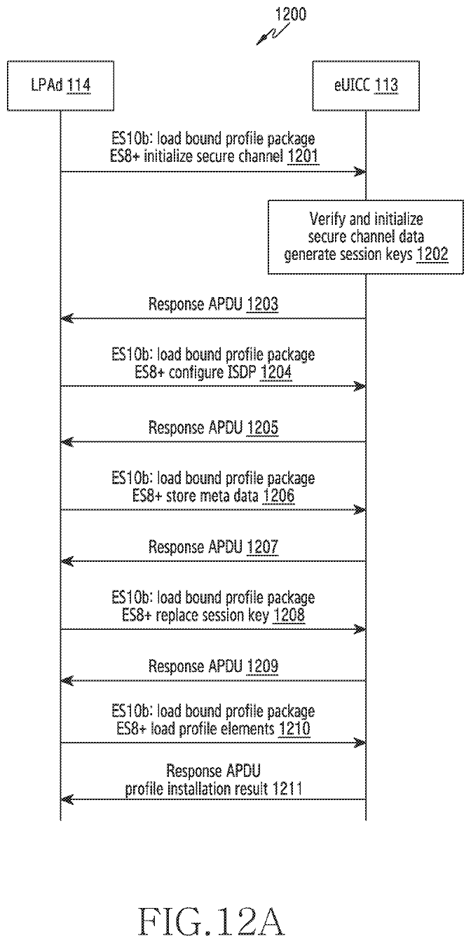

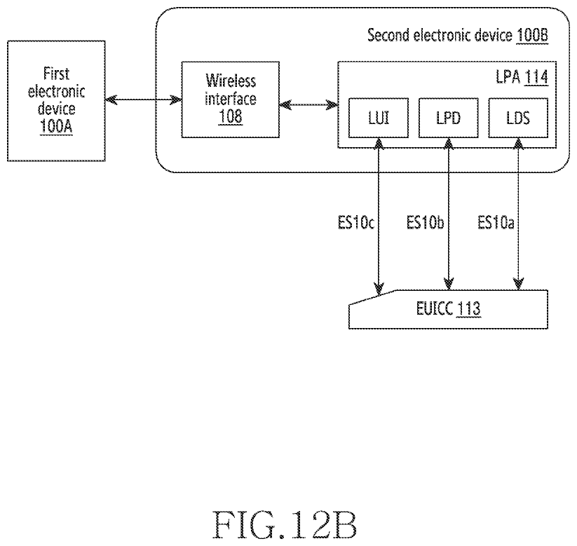

At step 414, the method 400 includes transferring, by the first electronic device 100A, the profile information from the virtual LPA module to the eSIM of the second electronic device 100B over the first connection, as described in greater detail below with reference to FIG. 12A, FIG. 12B, FIG. 15A and FIG. 15B. At step 415, the method 400 includes transferring the profile information to the eUICC of the second electronic device 100B. At step 416, the method 400 includes installing the profile information into the e-UICC module associated with the eSIM.

At step 417, the method 400 includes initializing, upon installing the profile information, by the second electronic device 100B, a connection with the network entity (e.g., operator 100D). The second electronic device 100B receives network information from the network entity and the network information comprises at least one of a mobile country code (MCC), a mobile network code (MNC), a last registered public land mobile network (PLMN), a Location Area Code (LAC), a Registered Public Land Mobile Network (RPLMN), a Globally Unique Temporary Identifier (GUTI), an Enhanced Hotspot (EHP), a Local Mobile Network (LMN), and other data. The other data comprises at least one of radio access technology (RAT) information, contact information, and user preference information. At step 418, the method 400 includes deactivating the pSIM of the first electronic device 100A when the eSIM is connected with the network entity.

The method 400 has several advantages such as a simple SIM (pSIM/eSIM) authentication process. One of the advantages is the decreased number of steps necessary, which eliminates the requirement for the entitlement server 100C. This leads to a more cost-effective SIM authentication procedure with less signaling, better network resource utilization, and a speedier eSIM provisioning mechanism. Furthermore, this method 400 is useful for Machine-to-Machine (M2M) or Internet of Things (IoT) devices and provides a user-friendly interface.

FIG. 5 is a block diagram illustrating an example configuration of a system 500 for transferring the profile information from the first electronic device 100A to the second electronic 100B, according to various embodiments.

In various embodiments, the system 500 includes the first electronic device 100A, the second electronic 100B, the entitlement server 100C, the operator 100D, the SM-DP server 100E, and the SM-DS server 100F. Examples of the first electronic device 100A to the second electronic 100B include, but are not limited to a smartphone, a tablet computer, a Personal Digital Assistance (PDA), an Internet of Things (IoT) device, a wearable device, etc.

The first electronic device 100A include a wireless interface 101, a processor (e.g., including processing circuitry) 102, a CAP protocol/Non Access Stratum (NAS) module 103, an STK module 104, a UIM 105, a UICC module 106 (pSIM), the virtual LPA module 107, a first memory (not shown in FIG. 5), and a first communicator (e.g., including communication circuitry) (not shown in FIG. 5). The second electronic 100B include a wireless interface (e.g., including various circuitry) 108, a processor (e.g., including processing circuitry) 109, a CAP protocol/Non Access Stratum (NAS) module 110, a STK module 111, a UIM 112, an eUICC module 113 (SIM), a LPAd module 114, a second memory (not shown in FIG. 5), and a second communicator (e.g., including communication circuitry) (not shown in FIG. 5). In an embodiment, LPA modules may be used on both the second electronic 100B and eUICC module 113. The first LPA module is located at the second electronic 100B side and is indicated by the suffix “d” LPAd for the second electronic 100B side, while the second LPA module is located at the eUICC side (113) and is indicated by the suffix “e”. The various module may include various circuitry and/or executable program instructions.

In an embodiment, the first memory/second memory stores instructions to be executed by the processor 102/109 which may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. For example, the processor 102/109 may execute instructions in the memory(ies) for transferring profile information associated with a physical subscriber identity module (pSIM) of a first electronic device to an embedded SIM (eSIM) of a second electronic device, as discussed throughout the disclosure. The first memory/second memory may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the first memory/second memory may, in some examples, be considered a non-transitory storage medium. The “non-transitory” storage medium is not embodied in a carrier wave or a propagated signal. However, the term “non-transitory” should not be interpreted that the first memory/second memory is non-movable. In various examples, the first memory/second memory can be configured to store larger amounts of information than the memory. In certain examples, a non-transitory storage medium may store data that can, over time, change (e.g., in Random Access Memory (RAM) or cache). The first memory/second memory can be an internal storage unit, or it can be an external storage unit of the electronic device (100), a cloud storage, or any other type of external storage.

The processor 102/109 communicates with the first memory/second memory, the first communicator/second communicator, and one or more modules (e.g., 103, 104, etc.), as mentioned above. The processor 102/109 is configured to execute instructions stored in the first memory/second memory and to perform various processes for transferring profile information associated with a physical subscriber identity module (pSIM) of a first electronic device to an embedded SIM (eSIM) of a second electronic device, as discussed throughout the disclosure. The processor 102/109 may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The first communicator/second communicator may include various communication circuitry and is configured for communicating internally between internal hardware components and with external devices (e.g., the operator 100D, the SM-DP server 100E, etc.) via one or more networks (e.g., radio technology). The first communicator/second communicator includes an electronic circuit specific to a standard that enables wired or wireless communication.

The processor 102/109 may be implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In various embodiments, the CAP protocol/NAS module 103 is configured to receive the SIM OTA message from the network entity (e.g., operator 100D) to create the EF-SMDP file directory. The CAP protocol/NAS module 103 is configured to determine whether the SMS-PP message for the received SIM OTA message belongs to the class-2 SMS (SMS to be saved in SIM card memory). In an embodiment, the CAP protocol/NAS module 103 is configured to utilize one or more layers/functionality of the existing network system, which are described in Table-3 below. In an embodiment, the CAP protocol/NAS module 103/110 is configured to communicate with the STK module 104.

TABLE-3

| | |
|---|---|
| SMS | This module is located in the NAS layer and is responsible for reading |
| | and parsing MO/MT SMS. Recognized that received SMS is of class 2 |
| | and needs to be passed to UICC. |
| Mobility management | It is used to trace physical user and subscriber locations to provide |
| | mobile phone services, like calls and Short Message Service (SMS). |
| RRC | The major functions of the RRC protocol include connection |
| | establishment and release functions, broadcast of system information, |
| | radio bearer establishment, reconfiguration and release, RRC |
| | connection mobility procedures, paging notification and release, and |
| | outer loop power control. In case of incoming SMS paging, it allows |
| | the radio resources to UE. |
| RLC | In the uplink, it provides a buffer status report, segmentation and |
| | concatenation, and Automatic Repeat Request (ARQ) (for Amplitude |
| | Modulation (AM) mode). In the downlink, it performs reordering, |
| | assembly, and ARQ(for AM mode). |
| MAC | In the uplink, it does channel mapping, multiplexing, handling control |
| | elements, random access procedure, logical channel priority, Hybrid |
| | Automatic Repeat Request (HARQ), and sending Buffer Status Reports |
| | (BSRs). In the downlink, it does channel mapping, De-multiplexing, |
| | Discontinuous Reception (DRX), handling control elements, and |
| | HARQ. |

In various embodiments, the STK module 104 is configured to send the envelope command to the UIM 105 in response to determining that the SMS-PP message belongs to the class-2 SMS. In other words, the STK module 104 is configured to send the envelope command of SMS PP download (SIM OTA) to the UIM 105. The envelope command is used to convey STK data to the UIM 105/UICC 106 in a transparent manner.

In various embodiments, the UIM 105 is configured to generate, upon receiving the envelop command, the APDU command to pass information associated with the received SIM OTA message to the UICC module 106.

In various embodiments, the UICC module 106 is configured to perform the one or more operations to create the EF-SMDP file directory. The one or more operations include receiving the information associated with the received SIM OTA message and decoding the information associated with the received SIM OTA message based on one or more pre-defined rules. The UICC module 106 is further configured to create, based upon the one or more operations, the EF-SMDP file directory in the memory/pSIM/UICC module 106. The UICC module 106 is further configured to generate a refresh proactive command, based on one or more pre-defined rules, to be read by the UIM 105 and shared this information (e.g., refresh proactive command) to the UIM 105. Then, the UIM 105 is further configured to determine one or more values associated with the created EF-SMDP file directory. The UIM 105 is further configured to store the one or more determined values associated with the created EF-SMDP file directory in the virtual LPA module 107.

In various embodiments, the processor 102 is configured to receive the SIM conversion request from the user over the first connection, as described in greater detail below with reference to FIG. 15A and FIG. 15B. The processor 102 is further configured to determine, upon receiving the SIM conversion request, whether the second electronic device 100B is eSIM compatible, based on the obtained EID associated with the second electronic device 100B. The processor 102 is further configured to establish the first connection (e.g., D2D connection) with the second electronic device 100B in response to determining that the second electronic device 100B is eSIM compatible by utilizing the wireless interface 101 and the wireless interface 108, as described in greater detail below with reference to FIG. 15A and FIG. 15B. The processor 102 is further configured to obtain the EID and the IMEI associated with the eSIM of the second electronic device 100B by utilizing the first connection associated with the first electronic device 100A and the second electronic device 100B.

In various embodiments, the processor 102 is further configured to send, using the created EF-SMDP file directory, the obtained EID, and the obtained IMEI, the first request directly to the SMDP server 100E (e.g., SM-DP+). The processor 102 is further configured to utilize the ES2+ connection between the operator 100D and the SMDP server 100E to order profiles for specific UICCs 106. The processor 102 is further configured to utilize the ES8+ connection between the virtual LPA module 107 and the SMDP server 100E to provide the secure end-to-end channel for the administration of ISD-P and associated profile during download and utilize the ES9+ connection between the virtual LPA module 107 and the SMDP server 100E to provide secure transport for the delivery of bound profile package (profile information). In other words, the processor 102 is further configured to obtain the authorization from the SMDP server 100E for the first request, wherein the virtual LPA module 107 stores, based upon authorization, the profile information, as described in greater detail below with reference to FIG. 11, FIG. 15A and FIG. 15B.

In various embodiments, the processor 102 is further configured to transfer the profile information from the virtual LPA module 107 to the eUICC module 113 (eSIM) over the first connection, as described in greater detail below with reference to FIG. 12A, FIG. 12B, FIG. 15A and FIG. 15B.

In various embodiments, the processor 109 is configured to install the profile information into eUICC module 113 by utilizing the LPAd module 114 and the eUICC module 113. The LPAd module 114 comprises three components: Local discover service (LDS), Local profile download (LPD), and Local user interface (LUI). The LPAd module 114 is configured to be used for profile package transfer and local profile management operations. The eUICC module 113 also has the same three components, eUICC contains MNO-enabled multiple profiles and can be updated over the air. In other words, it is a SIM card component that allows switching MNOs and may include three components (e.g., LPDe, LDSe, and LUIe) and MNO profiles may be changed over the air using, for example, the ES8/ES9 interface.

The processor 109 is further configured to initialize, upon installation, the profile information, the connection with the network entity (e.g., operator 100D) by utilizing the wireless interface 108. The processor 109 is further configured to receive the network information from the network entity and the network information comprises at least one of the MCC, the MNC, the PLMN, the LAC, the RPLMN, the GUTI, the EHPLMN, and other data. The other data comprises at least one of the RAT information, the contact information, and the user preference information. The processor 102 is further configured to deactivate the pSIM when the eSIM is connected with the network entity based on receiving information (e.g., connection initialization) from the processor 109.

Although FIG. 5 illustrates various hardware components of the system 500, but it is to be understood that other embodiments are not limited thereon. In other embodiments, the system 500 may include less or more number of components. Further, the labels or names of the components are used only for illustrative purposes and do not limit the scope of the disclosure. One or more components can be combined to perform the same or substantially similar functions to transfer the profile information associated with the pSIM of the first electronic device 100A to the eSIM of the second electronic device 100B.

FIG. 6 is a signal flow diagram illustrating an example method 600 for generating the envelope command, according to various embodiments.

At step 601, the method 600 includes sending, by a client (e.g., NAS module 103), the envelop command to the STK module 104. At step 602, the method 600 includes decoding, by the STK module 104, the envelop command and determining whether an error is present in the envelop command as per the predefined rules. For example, if one or more mandatory parameters (SMS-PP download tag+length+address+SMSTPDU) is missing, it may return an error. According to 3GPP TS 31.111, 7.1, data download to UICC, if the UICC (e.g., UICC module 106) responds with ‘93 00’, the UE must either retry the command or send an RP-ERROR message to the network with a traffic policing-frame relay congestion control scheme (TP-FCS) value indicating “SIM application toolkit busy”. At step 603, the method 600 includes sending, by the STK module 104, a PP envelop command to the UIM 105 in response to determining that the error is not present in the envelop command as per the predefined rules. At steps 604-605, the method 600 includes sending, by the UIM 105, the envelop command to the UICC module 106 and receiving an envelope response in response to sending the envelop command. At step 606, the method 600 includes sending, by the UIM 105, an envelope PP response to the STK module 104 in response to receiving the envelope response. At step 607, the method 600 includes building, by the STK module 104, a response structure in response to receiving the envelope PP response based on a predefined mechanism. For example, according to 3GPP TS 23.040 [5] and TS 24.011 [10], if the UICC module 106 answers with “90 00” or “6F XX” or “62 XX” or “63 XX”, the UE (e.g., first electronic device 100A) may confirm the receipt of a short message to the network using an retransmission positive acknowledgement (RP-ACK) message. The UE may include an UICC response data in a TP-User-Data part of the RP-ACK message it sends back to the network. At step 608, the method 600 includes forwarding the envelope PP response to the client.

FIGS. 7A and 7B are diagrams illustrating example architectures associated with a SIM toolkit (STK) module 104/111, according to various embodiments.

Referring to FIG. 7A: the architecture 701 includes an application processor and a communication processor, each of which may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The application processor includes a UI/Android telephony 702, and Android Radio Interface Layer (RIL)/components 703 (SECRIL SAT and SECRIL SEC). The communication processor includes an IPC (IPC SAT and IPC SEC) 704, the STK module 104/111, a SIM Interface 705, a UIM driver, and server 706.

The application processor is configured to manage a user interface (UI) and android telephony functions, which includes the Android RIL components that facilitate communication between Android applications and a modem. The Android RIL components 703 includes a Secure RIL for SIM Toolkit (SECRIL SAT) and a Secure RIL for Secure Element Connector (SECRIL SEC), which are two extensions of the Android RIL that provide additional security features, functionalities of these components are mentioned below.
a. The SECRIL SAT is configured to enable a secure communication between the SIM (e.g., pSIM/eSIM) card and an Android device (e.g., first electronic device 100A), ensure that sensitive information such as PIN codes and authentication data are protected from unauthorized access.
b. The SECRIL SEC is configured to provide a secure channel between the Android device and a secure element, which is a hardware component that stores sensitive information such as payment credentials. This ensures that the information is not compromised in transit and can only be accessed by authorized parties.

The communication processor is configured to deal with communication tasks within the STK module architecture by utilizing Inter-Process Communication (IPC) components 704, which may handle communication between various parts of the system. The communication processor is further configured to exchange of data and commands between different modules and interfaces within the system. The IPC components 704 includes an Inter-Process Communication for SIM Application Toolkit (IPC SAT) and an Inter-Process Communication for Secure Element Connector (IPC SEC), these are two communication protocols used in the first electronic device 100A and/or the second electronic device 100B to enable secure communication between different software components, functionalities of these components are mentioned below.
a. The IPC SAT is configured to enable communication between the STK and an Android operating system, allowing SIM-based applications to interact with the device's hardware and software. This includes features such as sending SMS messages, making phone calls and accessing the internet.
b. The IPC SEC is configured to enable communication between the SEC and the Android operating system. This allows secure elements to be used for applications such as mobile payments, digital signatures, and authentication.

The STK module 104/111 is a core of the SIM toolkit architecture. The STK module 104/111 is configured to interact with various components, including modem STK clients, the SIM interface clients, and the UIM driver and server 706. The STK module 104/111 is further configured to process SIM toolkit commands and responses, enabling the execution of SIM-related tasks and services. The SIM interface is configured to serve as a bridge between the STK 104/111 and other parts of the system. It communicates with the STK 104/111, the SIM interface clients (external applications or services), and the UIM driver and server 706. The UIM driver and server 706 are configured to manage the SIM card and its operations. The UIM driver and server 706 communicate directly with the SIM. Further, the UIM driver and server 706 may act as intermediaries between the STK module 104 and the physical SIM card, handling commands and data transfer.

Referring to FIG. 7B: illustrates an enlarged version 702 of the STK module 104/111, which communicates with the UIM driver and server 706, and the IPC components 704 by one or more functionalities, as per existing system, associated with at least one of a proactive command (refresh proactive command), the Envelope response, a state handler, the Envelope command, a terminal response, and a terminal profile. For example, according to proactive UICC 3GPP TS 31.111, proactive UICC gives a mechanism whereby the UICC module 106 may initiate actions to be taken by the UE (e.g., first electronic device 100A), In the disclosed method, the UICC module 106 is configured to issue the refresh proactive command, so that the UE may read the EF_SMDP file for SMDP server address. Once the UE reads the EF_SMDP file then after the UE responded to the UICC module 106 with the terminal response with a successful response. Additionally, the terminal profile is a command used by the UE to notify about one or more features supported by the UE as per the 3GPP TS 31.111, 5.2, structure and coding of terminal profile.

FIG. 8 is a diagram illustrating one or more layers 801 associated with the UIM 105/112, according to various embodiments.

The one or more layers 801 associated with the UIM 105/112 comprise a UIM task layer, a UIM server layer, and a UIM driver layer. Each layer communicates with each other and/or UIM client modules and/or SIM (e.g., pSIM/eSIM) with different interfaces such as server API interface (notation “1”, “2”, “3”, “4”, “5”, and “6”), a command response processing interface (notation “7” and “8”), a low-level driver API interface (notation “9” and “10”), and a hardware interface (notation “11” and “12”).

The notation “1” may indicate an SMS PP Download command to the UIM 105/112. The notation “1” may indicate a proactive command of refresh to read the EF-SMDP. The notation “5” may indicate a request to read the EF-SMDP by the virtual LPA module 107 from UIM Cache memory. The notation “6” may indicate the virtual LPA module 107 reads the one or more SM-DP values and stores in the virtual LPA module 107. The notation “4”, “8”, and “10” may indicate various layers of the UIM 105/112 reads the EF-SMDP and keeps in a cache. The notation “11” may indicate the APDU command sent to physical UICC (e.g., the UICC module 106) by the UIM driver layer to pass the SIM OTA. The notation “12” may indicate the proactive command for refresh is issued by the SIM card (e.g., pSIM/eSIM) to read the one or more EF-SMDP values by the first electronic device 100A and/or the second electronic device 100B.

FIG. 9 is a signal flow diagram illustrating an example method 900 for storing the one or more values associated with the EF-SMDP file directory in the virtual LPA module 107 of the first electronic device 100A, according to various embodiments.

At step 901, the method 900 includes the client NAS module 103 sends the SIM OTA message to the STK module 104. At step 902a, the method 900 includes sending the envelop command to the SIM interface 705 in response to receiving the SIM OTA message. At step 902b, the method 900 includes sending the envelop command to the UIM 105 in response to receiving the envelop command from the STK module 104. At step 902c, the method 900 includes sending the envelop command to the UICC module 106 in response to receiving the envelop command from the UIM 105. At step 903, the method 900 includes creating the EF-SMDP file directory in response to receiving the envelop command.

At step 904a, the method 900 includes sending the envelope response to the UIM 105 in response to creating the EF-SMDP file directory. At step 904b, the method 900 includes sending the envelope response to the STK module 104 in response to receiving the envelope response from the UIM 105. At step 905, the method 900 includes processing the response associated with the received envelope response. At step 906, the method 900 includes sending a fetch command to the UIM 105. At step 907, the method 900 includes sending the fetch command to the UICC module 106 in response to receiving the fetch command from the UIM 105.

At step 908, the method 900 includes sending a fetch response command (proactive command) to the UIM 105 in response to receiving the fetch command from the UIM 105. At step 909, the method 900 includes sending a proactive command (Refresh for EF_SMDP) to the STK module 104. At step 910, the method 900 includes processing the proactive command in response to receiving the proactive command from the STK module 104. At step 911, the method 900 includes sending a notification for SIM refresh to the SIM interface 705 after processing the proactive command. At step 912, the method 900 includes processing the notification in response to receiving the notification from the STK module 104. At step 913, the method 900 includes sending a read command for EF_SMDP to the UIM 105 after processing the notification. At step 914, the method 900 includes sending the read command to the UICC module 106 in response to receiving the read command from the UIM 105.

At step 915, the method 900 includes sending a read response for EF_SMDP to the UIM 105 in response to receiving the read command from the UIM 105. At step 916, the method 900 includes sending the read response to the SIM interface 705 in response to receiving the read response from the UICC module 106. At step 917, the method 900 includes sending/generating the one or more EF_SMDP values to the virtual LPA module 107. The virtual LPA module 107 stores the one or more EF_SMDP values (e.g., one or more values associated with the EF-SMDP file directory).

FIG. 10 is a flowchart illustrating an example method 1000 for storing the one or more values associated with the EF-SMDP file directory in the virtual LPA module 107 of the first electronic device 100A, according to various embodiments.

At steps 1001-1002, the method 1000 includes receiving, by the first electronic device 100A, the SIM OTA message from the network entity (e.g., Operator 100D) to create the EF-SMDP file directory. At step 1003, the method 1000 includes determining, by the first electronic device 100A, whether the SMS-PP message for the received SIM OTA message belongs to the class-2 SMS. At step 1004, the method 1000 includes not processing further steps associated with the storing the one or more values associated with the EF-SMDP file directory in the virtual LPA module 107 in response to determining that the SMS-PP message for the received SIM OTA message does not belong to the class-2 SMS.

At step 1005, the method 1000 includes sending, by the STK module 104, the envelope command to the UIM 105 in response to determining that the SMS-PP message belongs to the class-2 SMS. At steps 1006 and 1008, the method 1000 includes generating, upon receiving the envelop command, by the UIM 105, the APDU command to pass information associated with the received SIM OTA message to the UICC module 106. At step 1007, the method 1000 includes receiving the envelop response message in response to sending the envelop command. At step 1009, the method 1000 includes transferring one or more profile parameters associated with the profile information from the SMDP server, where the one or more profile parameters comprise at least one of profile metadata information, transaction identity information, and SMDP signature information/address information. At step 1010, the method 1000 includes storing the one or more received profile parameters associated with the profile information in the virtual LPA module 107.

FIG. 11 is a signal flow diagram illustrating an example method 1100 for storing the one or more received profile parameters associated with the profile information in the virtual LPA module 107 of the first electronic device 100A, according to various embodiments.

At step 1101, the method 1100 includes determining SMDP server information along with a uniform resource locator (URL) from the created EF-SMDP file directory. At step 1102, the method 1100 includes establishing the first connection (e.g., Hypertext Transfer Protocol (HTTP) connection) with the SMDP server 100E by utilizing the determined server information along with the URL. At step 1103, the method 1100 includes determining whether the second electronic device 100B is eSIM compatible, based on the obtained EID associated with the second electronic device 100B. At step 1104, the method 1100 includes initiating, by the SMDP server 100E, a download process for the profile information from the operator 100D by utilizing the ES2+ interface. At step 1105, the method 1100 includes receiving a response message from the operator 100D. At step 1106, the method 1100 includes building, by the SMDP server 100E, a profile metadata (one or more profile parameters) associated with the profile information. At step 1107, the method 1100 includes receiving, by the virtual LPA module 107, the one or more profile parameters associated with the profile information from the SMDP server 100E, wherein the one or more profile parameters comprise at least one of the profile metadata information, the transaction identity information, and the SMDP signature information. At step 1108, the method 1100 includes storing the one or more received profile parameters associated with the profile information in the virtual LPA module 107 and sharing a confirmation with the SMDP server 100E.

FIG. 12A is a signal flow diagram illustrating an example method 1200 for transferring the profile information, according to various embodiments.

At step 1201, the method 1200 includes loading bound profile package, by the LPAd module 114, to the eUICC module 113 using a ES10b interface and initializing, by the LPAd module 114, a secure channel between the LPAd module 114 and the eUICC module 113 using a ES8+ interface. At step 1202, the method 1200 includes verifying and initializing, by the eUICC module 113, the secure channel to generate one or more session keys. At step 1203, the method 1200 includes sending, by the eUICC module 113, a response APDU command to the LPAd module 114 corresponding to the previous step.

At step 1204, the method 1200 includes loading bound profile package, by the LPAd module 114, to the eUICC module 113 using the ES10b interface and configuring, by the LPAd module 114, Integrated Services Digital Platform (ISDP) using the ES8+ interface for the eUICC module 113. At step 1205, the method 1200 includes sending, by the eUICC module 113, the response APDU command to the LPAd module 114 corresponding to the previous step. At step 1206, the method 1200 includes loading bound profile package, by the LPAd module 114, to the eUICC module 113 using the ES10b interface and storing metadata at the eUICC module 113 using the ES8+ interface. At step 1207, the method 1200 includes sending, by the eUICC module 113, the response APDU command to the LPAd module 114 corresponding to the previous step.

At step 1208, the method 1200 includes loading bound profile package, by the LPAd module 114, to the eUICC module 113 using the ES10b interface and replacing session leys for the eUICC module 113. At step 1209, the method 1200 includes sending, by the eUICC module 113, the response APDU command to the LPAd module 114 corresponding to the previous step. At step 1210, the method 1200 includes loading bound profile package, by the LPAd module 114, to the eUICC module 113 using the ES10b interface and loading profile elements at the eUICC module 113. At step 1211, the method 1200 includes sending, by the eUICC module 113, the response APDU command to the LPAd module 114 corresponding to the previous step.

FIG. 12B is a diagram illustrating one or more modules associated with the second electronic device 100B for transferring the profile information, according to various embodiments.

The profile information is transferred via the wireless interface 108 to the LPA module 114 of the second electronic device 100B, where the LPA module 114 comprises the one or more modules (sub-modules) are configured to transfer the profile information to the eUICC module 113 via one or more interfaces (e.g., ES10a, ES10b, and ES10C). The ES10a interface is configured to handle a profile discovery, the ES10b interface is configured to bound profile package to the eUICC module 113, and the ES10C interface is configured to be used for local profile management by the end user.

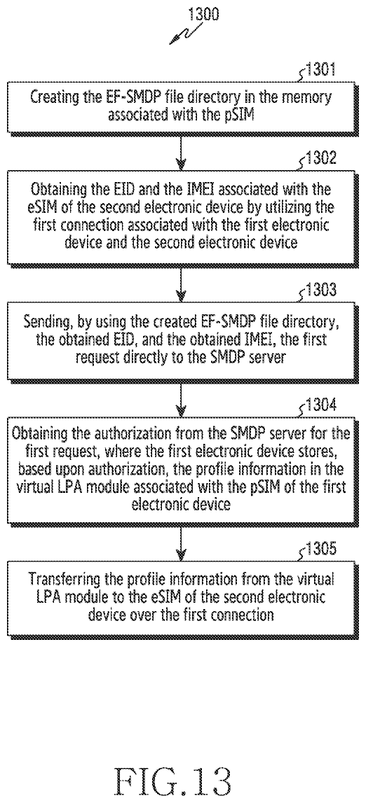

FIG. 13 is a flowchart illustrating an example method 1300 for transferring profile information associated with the pSIM of the first electronic device 100A to the eSIM of the second electronic device 100B, according to various embodiments.

At step 1301, the method 1300 includes creating the EF-SMDP file directory in the memory associated with the pSIM. At step 1302, the method 1300 includes obtaining the EID and the IMEI associated with the eSIM of the second electronic device 100B by utilizing the first connection associated with the first electronic device 100A and the second electronic device 100B. At step 1303, the method 1300 includes sending, using the created EF-SMDP file directory, the obtained EID, and the obtained IMEI, the first request directly to the SMDP server 100E. At step 1304, the method 1300 includes obtaining the authorization from the SMDP server 100E for the first request, where the first electronic device 100A stores, based upon authorization, the profile information in the virtual LPA module 107 associated with the pSIM of the first electronic device 100A. At step 1305, the method 1300 includes transferring the profile information from the virtual LPA module 107 to the eSIM of the second electronic device 100B over the first connection.

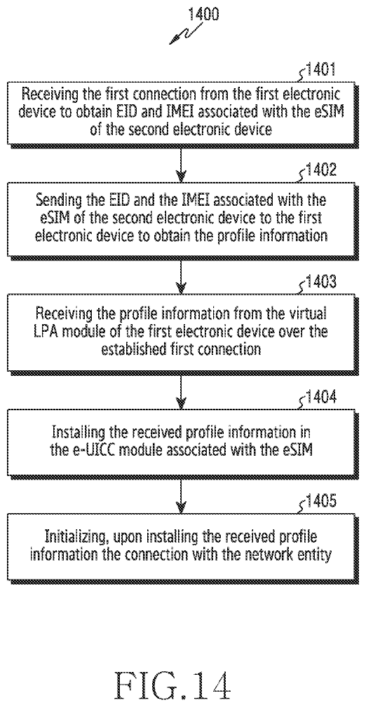

FIG. 14 is a flowchart illustrating an example method for handling the profile information associated with the pSIM of the first electronic device 100A at the eSIM of the second electronic device 100B, according to various embodiments.

At step 1401, the method 1400 includes receiving the first connection from the first electronic device 100A to obtain EID and IMEI associated with the eSIM of the second electronic device 100B. At step 1402, the method 1400 includes sending the EID and the IMEI associated with the eSIM of the second electronic device 100B to the first electronic device 100A to obtain the profile information. At step 1403, the method 1400 includes receiving the profile information from the virtual LPA module 107 of the first electronic device 100A over the established first connection. At step 1404, the method 1400 includes installing the received profile information in the e-UICC module 113 associated with the eSIM. At step 1405, the method 1400 includes initializing, upon installing the received profile information the connection with the network entity.

FIGS. 15A and 15B are diagrams illustrating example scenarios where a user transfers the profile information associated with the pSIM of the first electronic device 100A to the eSIM of the second electronic device 100B, according to various embodiments.

Referring to FIG. 15A: consider the following scenario 1501, the user of the electronic device purchases a new electronic device (e.g., smartphone/second electronic device 100B) and discovers that the second electronic device 100B is eSIM compatible 1502. The user then wants to convert/transfer the profile information associated with the pSIM of the first electronic device 100A to the eSIM of the second electronic device 100B. The user does an internet search for the same and it is a difficult/long task 1503. However, according to the disclosed method, the user has an easy solution 1504 (e.g., convert SIM to eSIM option/feature) to convert/transfer the profile information associated with the pSIM of the first electronic device 100A to the eSIM of the second electronic device 100B. Therefore, the user may easily perform task 1505, which improves the user's experience while saving resources and time for the eSIM provisioning.

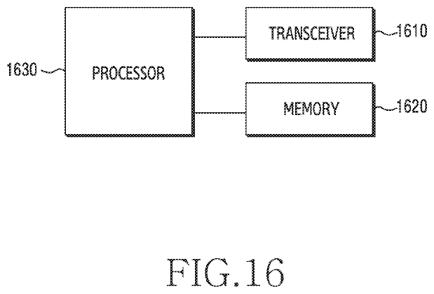

Referring to FIG. 15B: consider the following scenario 1506-1507, the user wants to convert/transfer the profile information associated with the pSIM of the first electronic device 100A to the eSIM of the second electronic device 100B (e.g., smart car). According to the disclosed method, the user has an easy solution 1508 (e.g., convert SIM to eSIM option/feature) to convert/transfer the profile information associated with the pSIM of the first electronic device 100A to the eSIM of the second electronic device 100B by connecting the second electronic device 100B using the D2D connection 1509. Therefore, the user may easily perform task 1510, which improves the user's experience while saving resources and time for the eSIM provisioning. FIG. 16 is a block diagram illustrating a structure of a device.

As shown in FIG. 16, the UE according to an embodiment may include a transceiver 1610, a memory 1620, and a processor 1630. The transceiver 1610, the memory 1620, and the processor 1630 of the UE may operate according to a communication method of the UE described above. However, the components of the UE are not limited thereto. For example, the UE may include more or fewer components than those described above. In addition, the processor 1630, the transceiver 1610, and the memory 1620 may be implemented as a single chip. Also, the processor 1630 may include at least one processor. Furthermore, the UE of FIG. 16 corresponds to the UE of the FIG. 3.

The transceiver 1610 collectively refers to a UE receiver and a UE transmitter, and may transmit/receive a signal to/from a base station or a network entity. The signal transmitted or received to or from the base station or a network entity may include control information and data. The transceiver 1610 may include a RF transmitter for up-converting and amplifying a frequency of a transmitted signal, and a RF receiver for amplifying low-noise and down-converting a frequency of a received signal. However, this is only an example of the transceiver 1610 and components of the transceiver 1610 are not limited to the RF transmitter and the RF receiver.

Also, the transceiver 1610 may receive and output, to the processor 1630, a signal through a wireless channel, and transmit a signal output from the processor 1630 through the wireless channel.

The memory 1620 may store a program and data required for operations of the UE. Also, the memory 1620 may store control information or data included in a signal obtained by the UE. The memory 1620 may be a storage medium, such as read-only memory (ROM), random access memory (RAM), a hard disk, a CD-ROM, and a DVD, or a combination of storage media.

The processor 1630 may control a series of processes such that the UE operates as described above. For example, the transceiver 1610 may receive a data signal including a control signal transmitted by the base station or the network entity, and the processor 1630 may determine a result of receiving the control signal and the data signal transmitted by the base station or the network entity.

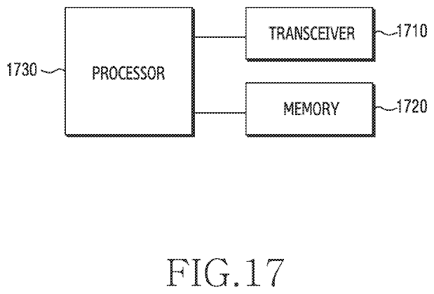

FIG. 17 is a block diagram illustrating a structure of an entity.

As shown in FIG. 17, the entity according to an embodiment may include a transceiver 1710, a memory 1720, and a processor 1730. The transceiver 1710, the memory 1720, and the processor 1730 of the entity may operate according to a communication method of the entity described above. However, the components of the entity are not limited thereto. For example, the entity may include more or fewer components than those described above. In addition, the processor 1730, the transceiver 1710, and the memory 1720 may be implemented as a single chip. Also, the processor 1730 may include at least one processor. Furthermore, the entity of FIG. 17 corresponds to a module, a server or the like in figures previously described.

The transceiver 1710 collectively refers to a receiver and transmitter, and may transmit/receive a signal to/from a device (or UE) or another entity. The signal transmitted or received to or from the device or an entity may include control information and data. The transceiver 1710 may include a RF transmitter for up-converting and amplifying a frequency of a transmitted signal, and a RF receiver for amplifying low-noise and down-converting a frequency of a received signal. However, this is only an example of the transceiver 1710 and components of the transceiver 1710 are not limited to the RF transmitter and the RF receiver.

Also, the transceiver 1710 may receive and output, to the processor 1730, a signal through a wireless channel, and transmit a signal output from the processor 1730 through the wireless channel.

The memory 1720 may store a program and data required for operations of the entity. Also, the memory 1720 may store control information or data included in a signal obtained by the entity. The memory 1720 may be a storage medium, such as read-only memory (ROM), random access memory (RAM), a hard disk, a CD-ROM, and a DVD, or a combination of storage media.

The processor 1730 may control a series of processes such that the entity operates as described above. For example, the transceiver 1710 may receive a data signal including a control signal transmitted by a device, and the processor 1730 may determine a result of receiving the control signal and the data signal transmitted by a device.

In various embodiments, a method for transferring profile information associated with a physical subscriber identity module (pSIM) of a first electronic device to an embedded SIM (eSIM) of a second electronic device, the method comprising: creating, by the first electronic device, an enhanced feature short message delivery point (EF-SMDP) file directory in a memory associated with the pSIM; obtaining, by the first electronic device, eSIM identity (EID) and international mobile equipment identity (IMEI) associated with the eSIM of the second electronic device utilizing a first connection associated with the first electronic device and the second electronic device; sending, using the created EF-SMDP file directory, the obtained EID, and the obtained IMEI, by the first electronic device, a first request directly to a subscription manager data preparation (SMDP) server; obtaining, by the first electronic device, an authorization from the SMDP server for the first request, wherein the first electronic device stores, based upon authorization, the profile information in a virtual Local Profile Assistant (LPA) module associated with the pSIM of the first electronic device; and transferring, by the first electronic device, the profile information from the virtual LPA module to the eSIM of the second electronic device over the first connection.

Preferably, the method further comprising: storing, by the first electronic device, the created EF-SMDP file directory in the virtual LPA module of the first electronic device; wherein the virtual LPA module comprises a local profile download (LPD) module, a local discovery services (LDS) module, and a local user interface (LUI) module; and wherein the created EF-SMDP file directory comprises SMDP server information along with a uniform resource locator (URL).

Preferably, wherein creating the EF-SMDP file directory comprises: receiving, by the first electronic device, a SIM over-the-air (OTA) message from the network entity to create the EF-SMDP file directory; determining, by the first electronic device, whether a Short Message Service Point to Point (SMS-PP) message for the received SIM OTA message belongs to a class-2 SMS; sending, by a SIM toolkit (STK) module of the first electronic device, an envelope command to a user identity module (UIM) of the first electronic device in response to determining that the SMS-PP message belongs to the class-2 SMS; generating, upon receiving the envelop command, by the UIM, an application protocol data unit (APDU) command to pass information associated with the received SIM OTA message to a universal integrated circuit card (UICC) module of the first electronic device; performing, by the UICC module of the first electronic device, one or more operations to create the EF-SMDP file directory, wherein the one or more operations comprise receiving the information associated with the received SIM OTA message and decoding the information associated with the received SIM OTA message based on one or more specified rules; and creating, based upon the one or more operations, by the UICC module of the first electronic device, the EF-SMDP file directory.

Preferably, the method, further comprising: generating, by the UICC module of the first electronic device, a refresh proactive command, based on one or more specified rules, to be read by the UIM; determining, by the UIM of the first electronic device, one or more values associated with the created EF-SMDP file directory; and storing, by the first electronic device, the one or more determined values associated with the created EF-SMDP file directory in the virtual LPA module of the first electronic device.

Preferably, the method further comprising: receiving, by the first electronic device, a SIM conversion request over the first connection; determining, upon receiving the SIM conversion request, by the first electronic device, whether the second electronic device is eSIM compatible, based on the obtained EID associated with the second electronic device; establishing, by the first electronic device, the first connection with the second electronic device in response to determining that the second electronic device is eSIM compatible.

Preferably, wherein the first electronic device storing the profile information in the virtual LPA module of the first electronic device comprises: receiving, by the first electronic device, one or more profile parameters associated with the profile information from the SMDP server, wherein the one or more profile parameters comprise at least one of profile metadata information, transaction identity information, and SMDP signature information; and storing, by the first electronic device, the one or more received profile parameters associated with the profile information in the virtual LPA module of the first electronic device.

Preferably, wherein obtaining, by the first electronic device, the authorization from the SMDP server for the first request comprises: receiving, by the virtual LPA module of the first electronic device, a response of the first request from the SMDP server, wherein the response comprises a plurality of keys; wherein the SMDP server authenticates the first request comprising SMDP server information and embedded Universal Integrated Circuit Card (eUICC) information associated with the eSIM of the second electronic device; and wherein the SMDP server generates the plurality of keys comprising at least one of a server signed key and a server signature key.

Preferably, the method further comprising: determining, by the virtual LPA module of the first electronic device, whether information associated with the received response is the same as stored information; sending, in response to determining that the information associated with the received response is the same as stored information, by the virtual LPA module of the first electronic device, the received response to the second electronic device to authenticate the plurality of keys; and sending, by the virtual LPA module of the first electronic device, an authentication response of the second electronic device to the SMDP server.

Preferably, the method further comprising: performing, by the first electronic device, one or more backend authentication operations, and one or more verification operations utilizing a web server associated with the network entity.

Preferably, the pSIM device does not perform authentication and verification procedure, based on the pSIM device already being present in an ongoing global system for mobile communication (GSM) session.

Preferably, the method further comprising: deactivating, by the first electronic device, the pSIM of the first electronic device after transferring the profile information to the eSIM of the second electronic device, wherein the eSIM of the second electronic device attaches to the network entity based on network information comprises at least one of a mobile country code (MCC), a mobile network code (MNC), a last registered public land mobile network (PLMN), and other data.

In various embodiments, A method for handling profile information associated with a physical subscriber identity module (pSIM) of a first electronic device at an embedded SIM (eSIM) of a second electronic device, the method comprising: receiving, by the second electronic device, a first connection from the first electronic device to obtain eSIM identity (EID) and international mobile equipment identity (IMEI) associated with the eSIM of the second electronic device; sending, by the second electronic device, the EID and the IMEI associated with the eSIM of the second electronic device to the first electronic device to obtain the profile information; receiving, by the second electronic device, the profile information from a virtual Local Profile Assistant (LPA) module of the first electronic device over the established first connection; installing, by the second electronic device, the received profile information in embedded universal integrated circuit card (e-UICC) module associated with the eSIM; and initializing, upon installing the received profile information, by the second electronic device, a connection with the network entity, wherein the second electronic device receives network information from the network entity and the network information comprises at least one of a mobile country code (MCC), a mobile network code (MNC), a last registered public land mobile network (PLMN), and other data, wherein the other data comprises at least one of radio access technology (RAT) information, contact information, and user preference information.

In various embodiments, A system for transferring profile information associated with a physical subscriber identity module (pSIM) of a first electronic device to an embedded SIM (eSIM) of a second electronic device, the system comprising: a memory; communication circuitry (or transceiver); at least one processor, comprising processing circuitry, individually and/or collectively, configured to: create an enhanced feature short message delivery point (EF-SMDP) file directory in a memory associated with the pSIM; obtain, using the established first connection, eSIM identity (EID) and international mobile equipment identity (IMEI) associated with the eSIM of the second electronic device utilizing a first connection associated with the first electronic device and the second electronic device; send, using the created EF-SMDP file directory, the obtained EID, and the obtained IMEI, a first request directly to a subscription manager data preparation (SMDP) server; obtain an authorization from the SMDP server for the first request, wherein the first electronic device stores the profile information in a virtual Local Profile Assistant (LPA) module associated with the pSIM of the first electronic device; and transfer, the profile information from the virtual LPA module to the eSIM of the second electronic device over the established first connection to connect with the network entity.

Preferably, wherein at least one processor, individually and/or collectively, is configured to: store the created EF-SMDP file directory in the virtual LPA module of the first electronic device; wherein the virtual LPA module comprises a local profile download (LPD) module, a local discovery services (LDS) module, and a local user interface (LUI) module; and wherein the created EF-SMDP file directory comprises SMDP server information along with a uniform resource locator (URL).

Preferably, wherein in creating the EF-SMDP file directory, at least one processor, individually and/or collectively, is configured to: receive a SIM over-the-air (OTA) message from the network entity to create the EF-SMDP file directory; determine whether a Short Message Service Point to Point (SMS-PP) message for the received SIM OTA message belongs to a class-2 SMS; send an envelope command to a user identity module (UIM) of the first electronic device in response to determining that the SMS-PP message belongs to the class-2 SMS; generate, upon receiving the envelop command, an application protocol data unit (APDU) command to pass information associated with the received SIM OTA message to a universal integrated circuit card (UICC) module of the first electronic device; perform one or more operations to create the EF-SMDP file directory, wherein the one or more operations comprise receiving the information associated with the received SIM OTA message and decoding the information associated with the received SIM OTA message based on one or more specified rules; and create, based upon the one or more operations, the EF-SMDP file directory.

Preferably, in the system, wherein at least one processor, individually and/or collectively, is configured to: generate a refresh proactive command, based on one or more specified rules, to be read by the UIM; determine one or more values associated with the created EF-SMDP file directory; and store the one or more determined values associated with the created EF-SMDP file directory in the virtual LPA module of the first electronic device.

Preferably, in the system, wherein at least one processor, individually and/or collectively, is configured to: receive a SIM conversion request from the user over the first connection; determine, upon receiving the SIM conversion request, whether the second electronic device is eSIM compatible, based on the obtained EID associated with the second electronic device; establish the first connection with the second electronic device in response to determining that the second electronic device is eSIM compatible.

Preferably, in the system, wherein the first electronic device is configured to store the profile information in the virtual LPA module of the first electronic device, and at least one processor, individually and/or collectively is configured to: receive one or more profile parameters associated with the profile information from the SMDP server, wherein the one or more profile parameters comprise at least one of profile metadata information, transaction identity information, and SMDP signature information; and store the one or more received profile parameters associated with the profile information in the virtual LPA module of the first electronic device.

Preferably, in the system, wherein to obtain the authorization from the SMDP server for the first request, at least one processor, individually and/or collectively, is configured to: receive a response of the first request from the SMDP server, wherein the response comprises a plurality of keys; wherein the SMDP server is configured to authenticate the first request comprising SMDP server information and embedded Universal Integrated Circuit Card (eUICC) information associated with the eSIM of the second electronic device (100B); and wherein the SMDP server is configured to generate the plurality of keys comprising at least one of a server signed key and a server signature key.

Preferably, in the system, wherein at least one processor, individually and/or collectively, is configured to: determine whether information associated with the received response is the same as stored information; send, in response to determining that the information associated with the received response is the same as stored information, the received response to the second electronic device to authenticate the plurality of keys; and send an authentication response of the second electronic device to the SMDP server.

Preferably, in the system, wherein at least one processor, individually and/or collectively, is configured to: perform one or more backend authentication operations, and one or more verification operations utilizing a web server associated with the network entity.

Preferably, in the system, the pSIM device does not perform authentication and verification procedure, based on the pSIM device already being present in an ongoing global system for mobile communication (GSM) session.

Preferably, in the system, wherein at least one processor, individually and/or collectively, is configured to: deactivate the pSIM of the first electronic device after transferring the profile information to the eSIM of the second electronic device, wherein the eSIM of the second electronic device is configured to attach to the network entity based on network information comprises at least one of a mobile country code (MCC), a mobile network code (MNC), a last registered public land mobile network (PLMN), and other data.

In various embodiments, A system for handling profile information associated with a physical subscriber identity module (pSIM) of a first electronic device at an embedded SIM (eSIM) of a second electronic device, the system comprising: a memory; communication circuitry (or transceiver); at least one processor, comprising processing circuitry, individually and/or collectively, configured to: receive a first connection from the first electronic device to obtain eSIM identity (EID) and international mobile equipment identity (IMEI) associated with the eSIM of the second electronic device; send the EID and the IMEI associated with the eSIM of the second electronic device to the first electronic device to obtain the profile information; receive the profile information from a virtual Local Profile Assistant (LPA) module of the first electronic device over the established first connection; install the received profile information in embedded universal integrated circuit card (e-UICC) module associated with the eSIM; and initialize, upon installing the received profile information, a connection with the network entity, wherein the second electronic device is configured to receive network information from the network entity and the network information comprises at least one of a mobile country code (MCC), a mobile network code (MNC), a last registered public land mobile network (PLMN), and other data, wherein the other data comprises at least one of radio access technology (RAT) information, contact information, and user preference information.

The various actions, acts, blocks, steps, or the like in the flow diagrams may be performed in the order presented, in a different order, or simultaneously. Further, in various embodiments, some of the actions, acts, blocks, steps, or the like may be omitted, added, modified, skipped, or the like without departing from the scope of the disclosure.

Unless otherwise defined, all technical and scientific terms used herein have the same meaning as commonly understood by one ordinary skilled in the art to which this disclosure belongs. The system, methods, and examples provided herein are illustrative only and not intended to be limiting.

While specific language has been used to describe the present subject matter, any limitations arising on account thereto, are not intended. As would be apparent to a person in the art, various working modifications may be made to the method to implement the concept as taught herein. The drawings and the forgoing description give examples of various embodiments. Those skilled in the art will appreciate that one or more of the described elements may well be combined into a single functional element. Certain elements may be split into multiple functional elements. Elements from one embodiment may be added to another embodiment.

The embodiments disclosed herein can be implemented using at least one hardware device and performing network management functions to control the elements.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method for transferring profile information associated with a physical subscriber identity module (pSIM) of a first electronic device to an embedded SIM (eSIM) of a second electronic device, the method comprising:
creating, by the first electronic device, an enhanced feature short message delivery point (EF-SMDP) file directory in a memory associated with the pSIM;
obtaining, by the first electronic device, eSIM identity (EID) and international mobile equipment identity (IMEI) associated with the eSIM of the second electronic device utilizing a first connection associated with the first electronic device and the second electronic device;
sending, using the created EF-SMDP file directory, the obtained EID, and the obtained IMEI, by the first electronic device, a first request directly to a subscription manager data preparation (SMDP) server;
obtaining, by the first electronic device, an authorization from the SMDP server for the first request, wherein the first electronic device stores, based upon authorization, the profile information in a virtual Local Profile Assistant (LPA) module associated with the pSIM of the first electronic device; and
transferring, by the first electronic device, the profile information from the virtual LPA module to the eSIM of the second electronic device over the first connection.

2. The method as claimed in claim 1, further comprising:
storing, by the first electronic device, the created EF-SMDP file directory in the virtual LPA module of the first electronic device;
wherein the virtual LPA module comprises a local profile download (LPD) module, a local discovery services (LDS) module, and a local user interface (LUI) module; and
wherein the created EF-SMDP file directory comprises SMDP server information along with a uniform resource locator (URL).

3. The method as claimed in claim 1, wherein creating the EF-SMDP file directory comprises:
receiving, by the first electronic device, a SIM over-the-air (OTA) message from the network entity to create the EF-SMDP file directory;
determining, by the first electronic device, whether a Short Message Service Point to Point (SMS-PP) message for the received SIM OTA message belongs to a class-2 SMS;
sending, by a SIM toolkit (STK) module of the first electronic device, an envelope command to a user identity module (UIM) of the first electronic device in response to determining that the SMS-PP message belongs to the class-2 SMS;
generating, upon receiving the envelop command, by the UIM, an application protocol data unit (APDU) command to pass information associated with the received SIM OTA message to a universal integrated circuit card (UICC) module of the first electronic device;
performing, by the UICC module of the first electronic device, one or more operations to create the EF-SMDP file directory, wherein the one or more operations comprise receiving the information associated with the received SIM OTA message and decoding the information associated with the received SIM OTA message based on one or more specified rules; and
creating, based upon the one or more operations, by the UICC module of the first electronic device, the EF-SMDP file directory.

4. The method as claimed in claim 3, further comprising:
generating, by the UICC module of the first electronic device, a refresh proactive command, based on one or more specified rules, to be read by the UIM;
determining, by the UIM of the first electronic device, one or more values associated with the created EF-SMDP file directory; and
storing, by the first electronic device, the one or more determined values associated with the created EF-SMDP file directory in the virtual LPA module of the first electronic device.

5. The method as claimed in claim 1, further comprising:
receiving, by the first electronic device, a SIM conversion request over the first connection;
determining, upon receiving the SIM conversion request, by the first electronic device, whether the second electronic device is eSIM compatible, based on the obtained EID associated with the second electronic device;
establishing, by the first electronic device, the first connection with the second electronic device in response to determining that the second electronic device is eSIM compatible.

6. The method as claimed in claim 1, wherein the first electronic device storing the profile information in the virtual LPA module of the first electronic device comprises:
receiving, by the first electronic device, one or more profile parameters associated with the profile information from the SMDP server, wherein the one or more profile parameters comprise at least one of profile metadata information, transaction identity information, and SMDP signature information; and
storing, by the first electronic device, the one or more received profile parameters associated with the profile information in the virtual LPA module of the first electronic device.

7. The method as claimed in claim 1, further comprising:
determining, by the virtual LPA module of the first electronic device, whether information associated with the received response is the same as stored information;
sending, in response to determining that the information associated with the received response is the same as stored information, by the virtual LPA module of the first electronic device, the received response to the second electronic device to authenticate the plurality of keys; and
sending, by the virtual LPA module of the first electronic device, an authentication response of the second electronic device to the SMDP server;
wherein obtaining, by the first electronic device, the authorization from the SMDP server for the first request comprises:
receiving, by the virtual LPA module of the first electronic device, a response of the first request from the SMDP server,
wherein the response comprises a plurality of keys,
wherein the SMDP server authenticates the first request comprising SMDP server information and embedded Universal Integrated Circuit Card (eUICC) information associated with the eSIM of the second electronic device, and
wherein the SMDP server generates the plurality of keys comprising at least one of a server signed key and a server signature key.

8. The method (1300) as claimed in claim 1, further comprising:
performing, by the first electronic device, one or more backend authentication operations, and one or more verification operations utilizing a web server associated with the network entity,
wherein the pSIM device does not perform authentication and verification procedure, based on the pSIM device already being present in an ongoing global system for mobile communication (GSM) session.

9. A method for handling profile information associated with a physical subscriber identity module (pSIM) of a first electronic device at an embedded SIM (eSIM) of a second electronic device, the method comprising:
receiving, by the second electronic device, a first connection from the first electronic device to obtain eSIM identity (EID) and international mobile equipment identity (IMEI) associated with the eSIM of the second electronic device;
sending, by the second electronic device, the EID and the IMEI associated with the eSIM of the second electronic device to the first electronic device to obtain the profile information;
receiving, by the second electronic device, the profile information from a virtual Local Profile Assistant (LPA) module of the first electronic device over the established first connection;
installing, by the second electronic device, the received profile information in embedded universal integrated circuit card (e-UICC) module associated with the eSIM; and
initializing, upon installing the received profile information, by the second electronic device, a connection with the network entity, wherein the second electronic device receives network information from the network entity and the network information comprises at least one of a mobile country code (MCC), a mobile network code (MNC), a last registered public land mobile network (PLMN), and other data, wherein the other data comprises at least one of radio access technology (RAT) information, contact information, and user preference information.

10. A system for transferring profile information associated with a physical subscriber identity module (pSIM) of a first electronic device to an embedded SIM (eSIM) of a second electronic device, the system comprising:
a transceiver;
a processor; and
memory storing instructions that, when executed by the processor, cause the system to:
create an enhanced feature short message delivery point (EF-SMDP) file directory in a memory associated with the pSIM;
obtain, using the established first connection, eSIM identity (EID) and international mobile equipment identity (IMEI) associated with the eSIM of the second electronic device utilizing a first connection associated with the first electronic device and the second electronic device;
send, using the created EF-SMDP file directory, the obtained EID, and the obtained IMEI, a first request directly to a subscription manager data preparation (SMDP) server;
obtain an authorization from the SMDP server for the first request, wherein the first electronic device stores the profile information in a virtual Local Profile Assistant (LPA) module associated with the pSIM of the first electronic device; and
transfer, the profile information from the virtual LPA module to the eSIM of the second electronic device over the established first connection to connect with the network entity.

11. The system as claimed in claim 10, wherein the memory further comprises the instructions that, when executed by the processor, cause the system to:
store the created EF-SMDP file directory in the virtual LPA module of the first electronic device (100A);
wherein the virtual LPA module comprises a local profile download (LPD) module, a local discovery services (LDS) module, and a local user interface (LUI) module; and
wherein the created EF-SMDP file directory comprises SMDP server information along with a uniform resource locator (URL).

12. The system as claimed in claim 10, wherein in creating the EF-SMDP file directory, the memory further comprises the instructions that, when executed by the processor, cause the system to:
receive a SIM over-the-air (OTA) message from the network entity to create the EF-SMDP file directory;
determine whether a Short Message Service Point to Point (SMS-PP) message for the received SIM OTA message belongs to a class-2 SMS;
send an envelope command to a user identity module (UIM) of the first electronic device in response to determining that the SMS-PP message belongs to the class-2 SMS;
generate, upon receiving the envelop command, an application protocol data unit (APDU) command to pass information associated with the received SIM OTA message to a universal integrated circuit card (UICC) module of the first electronic device;
perform one or more operations to create the EF-SMDP file directory, wherein the one or more operations comprise receiving the information associated with the received SIM OTA message and decoding the information associated with the received SIM OTA message based on one or more specified rules; and
create, based upon the one or more operations, the EF-SMDP file directory.

13. The system as claimed in claim 12, wherein the memory further comprises the instructions that, when executed by the processor, cause the system to:
generate a refresh proactive command, based on one or more specified rules, to be read by the UIM;
determine one or more values associated with the created EF-SMDP file directory; and
store the one or more determined values associated with the created EF-SMDP file directory in the virtual LPA module of the first electronic device.

14. The system as claimed in claim 10, wherein the memory further comprises the instructions that, when executed by the processor, cause the system to:
receive a SIM conversion request from the user over the first connection;
determine, upon receiving the SIM conversion request, whether the second electronic device is eSIM compatible, based on the obtained EID associated with the second electronic device;
establish the first connection with the second electronic device in response to determining that the second electronic device is eSIM compatible.

15. The system as claimed in claim 10, wherein the first electronic device is configured to store the profile information in the virtual LPA module of the first electronic device, and the memory further comprises the instructions that, when executed by the processor, cause the system to:
receive one or more profile parameters associated with the profile information from the SMDP server, wherein the one or more profile parameters comprise at least one of profile metadata information, transaction identity information, and SMDP signature information; and
store the one or more received profile parameters associated with the profile information in the virtual LPA module of the first electronic device.

16. The system as claimed in claim 10, wherein to obtain the authorization from the SMDP server for the first request, the memory further comprises the instructions that, when executed by the processor, cause the system to:
receive a response of the first request from the SMDP server,
wherein the response comprises a plurality of keys;
wherein the SMDP server is configured to authenticate the first request comprising SMDP server information and embedded Universal Integrated Circuit Card (eUICC) information associated with the eSIM of the second electronic device; and
wherein the SMDP server is configured to generate the plurality of keys comprising at least one of a server signed key and a server signature key.

17. The system as claimed in claim 16, wherein the memory further comprises the instructions that, when executed by the processor, cause the system to:
determine whether information associated with the received response is the same as stored information;
send, in response to determining that the information associated with the received response is the same as stored information, the received response to the second electronic device to authenticate the plurality of keys; and
send an authentication response of the second electronic device to the SMDP server.

18. A system for handling profile information associated with a physical subscriber identity module (pSIM) of a first electronic device at an embedded SIM (eSIM) of a second electronic device, the system comprising:
a transceiver;
a processor; and
memory storing instructions that, when executed by the processor, cause the system to:
receive a first connection from the first electronic device to obtain eSIM identity (EID) and international mobile equipment identity (IMEI) associated with the eSIM of the second electronic device;
send the EID and the IMEI associated with the eSIM of the second electronic device to the first electronic device to obtain the profile information;
receive the profile information from a virtual Local Profile Assistant (LPA) module of the first electronic device over the established first connection;
install the received profile information in embedded universal integrated circuit card (e-UICC) module associated with the eSIM; and
initialize, upon installing the received profile information, a connection with the network entity, wherein the second electronic device is configured to receive network information from the network entity and the network information comprises at least one of a mobile country code (MCC), a mobile network code (MNC), a last registered public land mobile network (PLMN), and other data, wherein the other data comprises at least one of radio access technology (RAT) information, contact information, and user preference information.

19. A non-transitory computer-readable recording medium storing a program including instructions that, when executed by a processor of a system for transferring profile information associated with a physical subscriber identity module (pSIM) of a first electronic device to an embedded SIM (eSIM) of a second electronic device, cause the system to perform operations comprising:
creating, by the first electronic device, an enhanced feature short message delivery point (EF-SMDP) file directory in a memory associated with the pSIM;
obtaining, by the first electronic device, eSIM identity (EID) and international mobile equipment identity (IMEI) associated with the eSIM of the second electronic device utilizing a first connection associated with the first electronic device and the second electronic device;
sending, using the created EF-SMDP file directory, the obtained EID, and the obtained IMEI, by the first electronic device, a first request directly to a subscription manager data preparation (SMDP) server;
obtaining, by the first electronic device, an authorization from the SMDP server for the first request, wherein the first electronic device stores, based upon authorization, the profile information in a virtual Local Profile Assistant (LPA) module associated with the pSIM of the first electronic device; and
transferring, by the first electronic device, the profile information from the virtual LPA module to the eSIM of the second electronic device over the first connection.

20. A non-transitory computer-readable recording medium storing a program including instructions that, when executed by a processor of a system for handling profile information associated with a physical subscriber identity module (pSIM) of a first electronic device at an embedded SIM (eSIM) of a second electronic device, cause the system to perform operations comprising:
receiving, by the second electronic device, a first connection from the first electronic device to obtain eSIM identity (EID) and international mobile equipment identity (IMEI) associated with the eSIM of the second electronic device;
sending, by the second electronic device, the EID and the IMEI associated with the eSIM of the second electronic device to the first electronic device to obtain the profile information;
receiving, by the second electronic device, the profile information from a virtual Local Profile Assistant (LPA) module of the first electronic device over the established first connection;
installing, by the second electronic device, the received profile information in embedded universal integrated circuit card (e-UICC) module associated with the eSIM; and
initializing, upon installing the received profile information, by the second electronic device, a connection with the network entity, wherein the second electronic device receives network information from the network entity and the network information comprises at least one of a mobile country code (MCC), a mobile network code (MNC), a last registered public land mobile network (PLMN), and other data, wherein the other data comprises at least one of radio access technology (RAT) information, contact information, and user preference information.
